(19) United States
(12) Patent Application Publication
(10) Pub. No.: US 2026/0186251 A1
(43) Pub. Date: Jul. 2, 2026

(54) CAMERA OPTICAL LENS

(71) Applicant: AAC OPTICS (CHANGZHOU) CO., LTD., Changzhou City (CN)

(72) Inventors: Minyi Xu, Changzhou (CN); Shunda Zhou, Changzhou (CN)

(21) Appl. No.: 19/292,965

(22) Filed: Aug. 7, 2025

Related U.S. Application Data
(63) Continuation of application No. PCT/CN2024/144599, filed on Dec. 31, 2024.

(51) Int. Cl. G02B 13/00; G02B 9/64

(52) U.S. Cl. CPC G02B 13/0045; G02B 9/64; G02B 13/008

(57) ABSTRACT

The present disclosure relates to the field of optical lens, and discloses a camera optical lens. The camera optical lens includes nine lenses in total, where from the object side to the image side, the nine lenses comprise in sequence: a first lens having a negative refractive power, a second lens having a negative refractive power, a third lens having a negative refractive power, a fourth lens having a positive refractive power, a fifth lens having a positive refractive power, a sixth lens having a negative refractive power, a seventh lens having a positive refractive power, an eighth lens having a positive refractive power, and a ninth lens having a positive refractive power. The camera optical lens possesses excellent optical performance in both visible and infrared light bands, and can control the total optical length of the camera optical system.

### CROSS REFERENCE TO RELATED APPLICATIONS

The present application is a continuation of PCT Patent Application No. PCT/CN2024/144599 entitled “Camera Optical Lens,” filed Dec. 31, 2024, which is incorporated by reference herein in its entirety.

### TECHNICAL FIELD

The present disclosure relates to optical lens, in particular to a camera optical lens.

### BACKGROUND

Camera optical lenses are widely used in mobile devices, automotive cameras, surveillance equipment, and other applications, particularly in smart mobile devices. As users' requirements for imaging capabilities of smart mobile devices increase, existing camera optical lenses are becoming increasingly inadequate to meet market demands.

In current camera optical lens designs, the number or size of lenses is often increased to enhance imaging performance, which leads to an increased total optical length of the entire lens system, hindering the realization of miniaturized designs. Furthermore, due to design flaws, existing camera optical lenses also suffer from significant chromatic aberration and noticeable temperature drift, which are detrimental to high-quality imaging.

### SUMMARY

The objective of embodiments of the present disclosure is to provide a large-aperture, wide-angle, dual-channel camera optical lens that exhibits excellent optical performance in both visible and infrared light bands. This lens controls the total optical length of the camera optical system, rationally allocates focal lengths of lenses, effectively mitigates temperature drift, moderates the deflection degree of light rays passing through lenses, efficiently corrects chromatic aberration, and enhances imaging performance.

In order to address the above technical issues, embodiments of the present disclosure provide a camera optical lens comprising nine lenses in total, where from the object side to the image side, the nine lenses comprise in sequence: a first lens having a negative refractive power, a second lens having a negative refractive power, a third lens having a negative refractive power, a fourth lens having a positive refractive power, a fifth lens having a positive refractive power, a sixth lens having a negative refractive power, a seventh lens having a positive refractive power, an eighth lens having a positive refractive power, and a ninth lens having a positive refractive power; an object side surface of the first lens is convex in a paraxial region, and an image side surface of the first lens is concave in the paraxial region; an object side surface of the second lens is convex in a paraxial region, and an image side surface of the second lens is concave in the paraxial region; an object side surface of the third lens is concave in a paraxial region, and an image side surface of the third lens is concave in the paraxial region; an object side surface of the fourth lens is convex in a paraxial region, and an image side surface of the fourth lens is convex in the paraxial region; an object side surface of the fifth lens is convex in a paraxial region, and an image side surface of the fifth lens is convex in the paraxial region; an object side surface of the sixth lens is convex in a paraxial region, and an image side surface of the sixth lens is concave in the paraxial region; an object side surface of the seventh lens is convex in a paraxial region, and an image side surface of the seventh lens is convex in the paraxial region; an object side surface of the eighth lens is concave in a paraxial region, and an image side surface of the eighth lens is convex in the paraxial region; an object side surface of the ninth lens is convex in a paraxial region, and an image side surface of the ninth lens is convex in the paraxial region; a central curvature radius of the object side surface of the second lens is denoted as R3, a central curvature radius of the image side surface of the second lens is denoted as R4, a focal length of the fifth lens is denoted as f5, an on-axis distance between the fifth lens and the sixth lens is denoted as d10, a focal length of the camera optical lens is denoted as f, a total track length of the camera optical lens is denoted as TTL, and the camera optical lens satisfies the following: 2.00≤R3/R4≤4.00; 4.30≤f5/f≤6.80; and 0.09≤d10/TTL≤0.15.

In some embodiments, the refractive index of the first lens is denoted as nd1, and nd1 satisfies the following: 1.70≤nd1≤2.20.

In some embodiments, the refractive index nd1 of the first lens satisfies the following: 1.71≤nd1≤1.82.

In some embodiments, a focal length of the third lens is denoted as f3, a focal length of the fourth lens is denoted as f4, f3 and f4 satisfy the following: −0.60≤f3/f4≤−0.45.

In some embodiments, a field of view of the camera optical lens at the 1.0 field is denoted as FOV, and the image height of the camera optical lens at the 1.0 field is denoted as IH, FOV and IH satisfy the following: 60.00≤(FOV*f)/IH≤75.00.

In some embodiments, the camera optical lens satisfies the following: 62.00≤(FOV*f)/IH≤75.00.

In some embodiments, a back focal length of the camera optical lens is denoted as BFL, and the camera optical lens satisfies the following: 0.05≤BFL/TTL≤0.10.

In some embodiments, a central curvature radius of the object side surface of the first lens is denoted as R1, a central curvature radius of the image side surface of the first lens is denoted as R2, a focal length of the first lens is denoted as f1, an on-axis thickness of the first lens is denoted as d1, and the camera optical lens satisfies the following: 1.34≤(R1+R2)/(R1−R2)≤1.55; −8.33≤f1/f≤−5.82; 0.05≤d1/TTL≤0.09.

In some embodiments, a focal length of the second lens is denoted as f2, an on-axis thickness of the second lens is denoted as d3, the camera optical lens satisfies the following: 1.66≤(R3+R4)/(R3−R4)≤3.00; −6.80≤f2/f≤−4.95; 0.01≤d3/TTL≤0.06.

In some embodiments, a central curvature radius of the object side surface of the third lens is denoted as R5, a central curvature radius of the image side surface of the third lens is denoted as R6, a focal length of the third lens is denoted as f3, an on-axis thickness of the third lens is denoted as d5, and the camera optical lens satisfies the following: −0.24≤(R5+R6)/(R5−R6)≤−0.07; −4.29≤f3/f≤−2.97; 0.01≤d5/TTL≤0.04.

In some embodiments, a central curvature radius of the object side surface of the fourth lens is denoted as R7, a central curvature radius of the image side surface of the fourth lens is denoted as R8, a focal length of the fourth lens is denoted as f4, an on-axis thickness of the fourth lens is denoted as d7, and the camera optical lens satisfies the following: −0.10≤(R7+R8)/(R7−R8)≤0.01; 6.09≤f4/f≤8.26; 0.22≤d7/TTL≤0.26.

In some embodiments, a central curvature radius of the object side surface of the fifth lens is denoted as R9, a central curvature radius of the image side surface of the fifth lens is denoted as R10, an on-axis thickness of the fifth lens is denoted as d9, and the camera optical lens satisfies the following: −0.39≤(R9+R10)/(R9−R10)≤−0.32; 4.32≤f5/f≤6.74; 0.09≤d9/TTL≤0.14.

In some embodiments, a central curvature radius of the object side surface of the sixth lens is denoted as R11, a central curvature radius of the image side surface of the sixth lens is denoted as R12, a focal length of the sixth lens is denoted as f6, an on-axis thickness of the sixth lens is denoted as d11, and the camera optical lens satisfies the following: 3.04≤(R11+R12)/(R11−R12)≤3.52; −4.50≤f6/f≤−3.49; 0.01≤d11/TTL≤0.02.

In some embodiments, a central curvature radius of the object side surface of the seventh lens is denoted as R13, a central curvature radius of the image side surface of the seventh lens is denoted as R14, a focal length of the seventh lens is denoted as f7, an on-axis thickness of the seventh lens is denoted as d13, and the camera optical lens satisfies the following: −0.51≤(R13+R14)/(R11−R12)≤−0.39; 1.87≤f7/f≤2.50; 0.03≤d13/TTL≤0.05.

In some embodiments, a central curvature radius of the object side surface of the eighth lens is denoted as R15, a central curvature radius of the image side surface of the eighth lens is denoted as R16, a focal length of the eighth lens is denoted as f8, an on-axis thickness of the eighth lens is denoted as d15, and the camera optical lens satisfies the following: 0.08≤(R15+R16)/(R11−R12)≤0.41; −3.20≤f8/f≤7.70; 0.00≤d15/TTL≤0.02.

In some embodiments, a central curvature radius of the object side surface of the ninth lens is denoted as R17, a central curvature radius of the image side surface of the ninth lens is denoted as R18, a focal length of the ninth lens is denoted as f9, an on-axis thickness of the ninth lens is denoted as d17, and the camera optical lens satisfies the following: −0.95≤(R17+R18)/(R11−R12)≤−0.16; −3.30≤f9/f≤5.10; 0.00≤d17/TTL≤0.04.

In some embodiments, the first lens, the second lens, the third lens, the fourth lens, the fifth lens, the sixth lens, the seventh lens, the eighth lens, and the ninth lens are glass lenses.

The present disclosure has the following beneficial effects. The above configuration of the nine lenses provides a large-aperture, wide-angle, dual-channel vehicle-mounted optical lens that exhibits excellent optical performance in both visible and infrared light bands. This lens controls the total optical length of the camera optical system, rationally allocates focal lengths of lenses, effectively mitigates temperature drift, moderates the deflection degree of light rays passing through lenses, efficiently corrects chromatic aberration, and enhances imaging performance.

### BRIEF DESCRIPTION OF THE DRAWINGS

One or more embodiments are illustrated through the figures in the corresponding drawings. These exemplary illustrations do not constitute limitations on the embodiments unless otherwise stated. Like reference signs in the accompanying drawings denote like elements. The figures in the accompanying drawings do not constitute a scale limitation unless otherwise explicitly stated.

FIG. 1 is a schematic structural diagram of a camera optical lens according to a first embodiment of the present disclosure;

FIG. 2 presents a schematic diagram of the field curvature and distortion of the camera optical lens shown in FIG. 1;

FIG. 3 illustrates the magnification chromatic aberration of the camera optical lens shown in FIG. 1;

FIG. 4 illustrates the longitudinal aberration of the camera optical lens shown in FIG. 1;

FIG. 5 is a schematic structural diagram of a camera optical lens according to a second embodiment of the present disclosure;

FIG. 6 presents a schematic diagram of the field curvature and distortion of the camera optical lens shown in FIG. 5;

FIG. 7 illustrates the magnification chromatic aberration of the camera optical lens shown in FIG. 5;

FIG. 8 illustrates the longitudinal aberration of the camera optical lens shown in FIG. 5;

FIG. 9 is a schematic structural diagram of a camera optical lens according to a third embodiment of the present disclosure;

FIG. 10 presents a schematic diagram of the field curvature and distortion of the camera optical lens shown in FIG. 9;

FIG. 11 illustrates the magnification chromatic aberration of the camera optical lens shown in FIG. 9;

FIG. 12 illustrates the longitudinal aberration of the camera optical lens shown in FIG. 9;

FIG. 13 is a schematic structural diagram of a camera optical lens according to a fourth embodiment of the present disclosure;

FIG. 14 presents a schematic diagram of the field curvature and distortion of the camera optical lens shown in FIG. 13;

FIG. 15 illustrates the magnification chromatic aberration of the camera optical lens shown in FIG. 13;

FIG. 16 illustrates the longitudinal aberration of the camera optical lens shown in FIG. 13;

FIG. 17 is a schematic structural diagram of a camera optical lens according to a fifth embodiment of the present disclosure;

FIG. 18 presents a schematic diagram of the field curvature and distortion of the camera optical lens shown in FIG. 17;

FIG. 19 illustrates the magnification chromatic aberration of the camera optical lens shown in FIG. 17;

FIG. 20 illustrates the longitudinal aberration of the camera optical lens shown in FIG. 17;

FIG. 21 is a schematic structural diagram of a camera optical lens according to a sixth embodiment of the present disclosure;

FIG. 22 presents a schematic diagram of the field curvature and distortion of the camera optical lens shown in FIG. 21;

FIG. 23 illustrates the magnification chromatic aberration of the camera optical lens shown in FIG. 21;

FIG. 24 illustrates the longitudinal aberration of the camera optical lens shown in FIG. 21;

FIG. 25 is a schematic structural diagram of a camera optical lens according to a comparative embodiment of the present disclosure;

FIG. 26 presents a schematic diagram of the field curvature and distortion of the camera optical lens shown in FIG. 25;

FIG. 27 illustrates the magnification chromatic aberration of the camera optical lens shown in FIG. 25; and

FIG. 28 illustrates the longitudinal aberration of the camera optical lens shown in FIG. 25.

### DETAILED DESCRIPTION OF THE EMBODIMENTS

In order to make the object, technical solution and advantages of the embodiments of the present disclosure clearer, the following gives a detailed description of the embodiments of the present disclosure with reference to the accompanying drawings. However, those of ordinary skill in the art may understand that in the embodiments of the present disclosure, many technical details have been presented to facilitate a better understanding of the present disclosure by the reader. However, even without these technical details and the various variations and modifications based on the following embodiments, the technical solution claimed in the present disclosure can still be achieved.

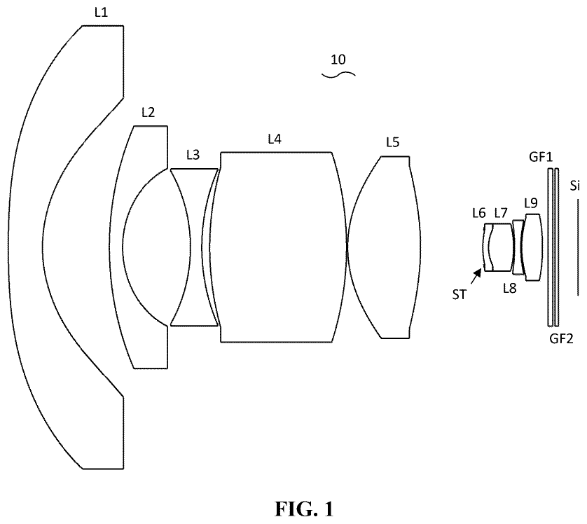

Referring to FIGS. 1, 5, 9, 13, 17 and 21, embodiments of the present disclosure provide camera optical lenses 10, 20, 30, 40, 50, and 60, each of which includes nine lenses in total. Specifically, from the object side to the image side, the camera optical lens comprises in sequence: a first lens L1 having a negative refractive power, a second lens L2 having a negative refractive power, a third lens L3 having a negative refractive power, a fourth lens L4 having a positive refractive power, a fifth lens L5 having a positive refractive power, a sixth lens L6 having a negative refractive power, a seventh lens L7 having a positive refractive power, an eighth lens L8 having a positive refractive power, and a ninth lens L9 having a positive refractive power.

An object side surface of the first lens L1 is convex in a paraxial region, and an image side surface of the first lens L1 is concave in the paraxial region; an object side surface of the second lens L2 is convex in a paraxial region, and an image side surface of the second lens L2 is concave in the paraxial region; an object side surface of the third lens L3 is concave in a paraxial region, and an image side surface of the third lens L3 is concave in the paraxial region; an object side surface of the fourth lens L4 is convex in a paraxial region, and an image side surface of the fourth lens L4 is convex in the paraxial region; an object side surface of the fifth lens L5 is convex in a paraxial region, and an image side surface of the fifth lens L5 is convex in the paraxial region; an object side surface of the sixth lens L6 is convex in a paraxial region, and an image side surface of the sixth lens L6 is concave in the paraxial region; an object side surface of the seventh lens L7 is convex in a paraxial region, and an image side surface of the seventh lens L7 is convex in the paraxial region; an object side surface of the eighth lens L8 is concave in a paraxial region, and an image side surface of the eighth lens L8 is convex in the paraxial region; and an object side surface of the ninth lens L9 is convex in a paraxial region, and an image side surface of the ninth lens L9 is convex in the paraxial region. The object side surfaces and image side surfaces of the first lens L1, second lens L2, third lens L3, fourth lens L4, fifth lens L5, sixth lens L6, seventh lens L7, eighth lens L8, and ninth lens L9 may alternatively be arranged in other concave or convex configurations.

A central curvature radius of the object side surface of the second lens L2 is denoted as R3, a central curvature radius of the image side surface of the second lens L2 is denoted as R4, a focal length of the fifth lens L5 is denoted as f5, an on-axis distance between the fifth lens L5 and the sixth lens L6 is denoted as d10, a focal length of the camera optical lens 10, 20, 30, 40, 50, or 60 is denoted as f, a total track length of the camera optical lens 10, 20, 30, 40, 50, or 60 is denoted as TTL, and the camera optical lens 10, 20, 30, 40, 50, or 60 satisfies the following:

$$2. \leq R 3 / R 4 \leq 4. ; \qquad ( 1 )$$

$$4.3 \leq f 5 / f \leq 6.8 ; \qquad ( 2 )$$

$$0.09 \leq d 10 / TTL \leq 0.15 . \qquad ( 3 )$$

Conditional expression (1) specifies the shape of the second lens L2. Within the range defined by Conditional expression (1), it can alleviate the degree of light deflection through the second lens L2, effectively correcting chromatic aberration. Specifically, in the visible light wavelength range, it enables chromatic aberration |LC|≤4.0 μm.

Conditional expression (2) specifies the range for the ratio of the focal length f5 of the fifth lens L5 to the focal length f of the camera optical lens 10, 20, 30, 40, 50, or 60. Within this range, it controls the focal length value of the fifth lens L5, achieves appropriate distribution of focal lengths, mitigates thermal drift, and enhances the temperature performance of the camera optical lens 10, 20, 30, 40, 50, or 60.

Conditional expression (3) specifies the range for the ratio of the on-axis distance d10 between the fifth lens L5 and the sixth lens L6 to the total track length TTL of the camera optical lens 10, 20, 30, 40, 50, or 60. When the aperture stop ST is positioned between the fifth lens L5 and the sixth lens L6, this facilitates smooth transition of light rays near the aperture stop ST, thereby improving imaging quality. Moreover, keeping the ratio at or below 0.15 effectively controls the total track length TTL, preventing excessive size of the camera optical lens 10, 20, 30, 40, 50, or 60.

According to the solution of the present disclosure, the above configuration of the lenses provides a large-aperture, wide-angle, dual-channel optical lens 10, 20, 30, 40, 50, or 60 that exhibits excellent optical performance in both visible and infrared light bands. This lens controls the total optical length of the camera optical system, rationally allocates focal lengths of lenses, effectively mitigates temperature drift, moderates the deflection degree of light rays passing through lenses, efficiently corrects chromatic aberration, and enhances imaging performance.

It should be noted that the units of the aforementioned central curvature radius, focal length, on-axis distance, and total track length are millimeters.

The refractive index of the first lens L1 is defined as nd1, and n1 satisfies the following conditional expression:

$$1.7 \leq nd 1 \leq 2.2 . \qquad ( 4 )$$

Conditional expression (4) specifies the range of the refractive index nd1 of the first lens L1. The first lens L1 preferably employs a material with a higher refractive index, thereby reducing the front aperture of the camera optical lens 10, 20, 30, 40, 50, or 60 and enhancing its imaging quality. Preferably, 1.71≤nd1≤1.82.

A focal length of the third lens L3 is denoted as f3, a focal length of the fourth lens L4 is denoted as f4, f3 and f4 satisfy the following conditional expression:

$$- 0.6 \leq f 3 / f 4 \leq - 0.45 . \qquad ( 5 )$$

Conditional expression (5) specifies the range for the ratio of the focal length f3 of the third lens L3 to the focal length f4 of the fourth lens L4. Through appropriate distribution of the focal lengths of the third lens L3 and the fourth lens L4, it facilitates smooth transition of large-angle rays, thereby enhancing imaging quality.

In some embodiments, a field of view of the camera optical lens 10, 20, 30, 40, 50, or 60 at the 1.0 field is denoted as FOV, and the image height of the camera optical lens 10, 20, 30, 40, 50, or 60 at the 1.0 field is denoted as IH, FOV and IH satisfy the following:

$$60. \leq ( FOV * f ) / IH \leq 75. . \qquad ( 6 )$$

When satisfying the constraints of Conditional expression (6), the imaging optical lens 10, 20, 30, 40, 50, or 60 can balance both a large field of view and telephoto capability, achieving imaging at middle-to-far distances. Preferably, 62.00≤(FOV*f)/IH≤75.00.

A back focal length of the camera optical lens 10, 20, 30, 40, 50, or 60 is denoted as BFL, and the camera optical lens satisfies the following:

$$0.05 \leq BFL / TTL \leq 0.1 . \qquad ( 7 )$$

Conditional expression (7) specifies the range for the ratio of the back focal length (BFL) to the total track length (TTL) of the camera optical lens 10, 20, 30, 40, 50, or 60. Under this constraint, it enables control of the BFL magnitude while achieving miniaturization, thereby facilitating assembly of the camera module, reducing lens sensitivity to MTF, improving production yield, and lowering manufacturing costs.

When satisfying the above conditional expressions, the camera optical lens 10, 20, 30, 40, 50, or 60 achieves good optical performance across both visible and infrared bands while meeting the design requirements for dual-channel optical imaging lenses with large aperture and wide-angle characteristics.

Based on the above conditional expressions and the functions intended to achieved, the characteristics of each lens are further detailed as follows.

A central curvature radius of the object side surface of the first lens L1 is denoted as R1, a central curvature radius of the image side surface of the first lens L1 is denoted as R2, a focal length of the first lens L1 is denoted as f1, an on-axis thickness of the first lens L1 is denoted as d1, and the camera optical lens satisfies the following:

$$1.34 \leq ( R 1 + R 2 ) / ( R 1 - R 2 ) \leq 1.55 ; \qquad ( 8 )$$

$$- 8.33 \leq f 1 / f \leq - 5.82 ; \qquad ( 9 )$$

$$0.05 \leq d 1 / TTL \leq 0.09 . \qquad ( 10 )$$

Conditional expression (8) specifies the shape of the first lens L1. Within this defined range, it helps reduce spherical aberration in the camera optical lens 10, 20, 30, 40, 50, or 60, thereby improving imaging quality. Conditional expression (9) specifies the ratio of the focal length f1 of the first lens L1 to the focal length f of the camera optical lens 10, 20, 30, 40, 50, or 60. Having an appropriate negative refractive power, the first lens L1 helps minimize aberrations in the camera optical lens 10, 20, 30, 40, 50, or 60. Conditional expression (10) specifies the range for the ratio of the on-axis thickness d1 of the first lens L1 to the optical total track length TTL of the camera optical lens 10, 20, 30, 40, 50, or 60, facilitating control over the optical total track length TTL.

A focal length of the second lens L2 is denoted as f2, an on-axis thickness of the second lens L2 is denoted as d3, the camera optical lens satisfies the following:

$$1.66 \leq ( R 3 + R 4 ) / ( R 3 - R 4 ) \leq 3. ; \qquad ( 11 )$$

$$- 6.8 \leq f 2 / f \leq - 4.95 ; \qquad ( 12 )$$

$$0.01 \leq d 3 / TTL \leq 0.06 . \qquad ( 13 )$$

Conditional expression (11) specifies the shape of the second lens L2, which can alleviate the degree of light deflection through the second lens L2, effectively correcting chromatic aberration. Conditional expression (12) specifies the ratio of the focal length f2 of the second lens L2 to the focal length f of the camera optical lens 10, 20, 30, 40, 50, or 60. This enables the second lens L2 to possess appropriate negative refractive power, helping reduce aberrations. Conditional expression (13) specifies the on-axis thickness d3 of the second lens L2, which effectively reduces the optical total track length TTL of the camera optical lens 10, 20, 30, 40, 50, or 60 while supporting miniaturization design.

A central curvature radius of the object side surface of the third lens L3 is denoted as R5, a central curvature radius of the image side surface of the third lens L3 is denoted as R6, a focal length of the third lens L3 is denoted as f3, an on-axis thickness of the third lens L3 is denoted as d5, and the camera optical lens satisfies the following:

$$- 0.24 \leq ( R 5 + R 6 ) / ( R 5 - R 6 ) \leq - 0.07 ; \qquad ( 14 )$$

$$- 4.29 \leq f 3 / f \leq - 2.97 ; \qquad ( 15 )$$

$$0.01 \leq d 5 / TTL \leq 0.04 . \qquad ( 16 )$$

Conditional expression (14) specifies the shape of the third lens L3, which effectively corrects spherical aberration in the camera optical lens 10, 20, 30, 40, 50, or 60 to enhance imaging quality. Conditional expression (15) specifies the focal length f3 of the third lens L3. Within this range, it enhances the optical performance of the camera optical lens 10, 20, 30, 40, 50, or 60. Conditional expression (16) specifies the on-axis thickness d5 of the third lens L3, facilitating control over the optical total track length TTL of the camera optical lens 10, 20, 30, 40, 50, or 60.

A central curvature radius of the object side surface of the fourth lens L4 is denoted as R7, a central curvature radius of the image side surface of the fourth lens L4 is denoted as R8, a focal length of the fourth lens L4 is denoted as f4, an on-axis thickness of the fourth lens L4 is denoted as d7, and the camera optical lens satisfies the following:

$$- 0.1 \leq ( R 7 + R 8 ) / ( R 7 - R 8 ) \leq 0.01 ; \qquad ( 17 )$$

$$6.09 \leq f 4 / f \leq 8.26 ; \qquad ( 18 )$$

$$0.22 \leq d 7 / TTL \leq 0.26 . \qquad ( 19 )$$

Conditional expression (17) specifies the shape of the fourth lens L4, which effectively corrects spherical aberration in the camera optical lens 10, 20, 30, 40, 50, or 60 to enhance imaging quality. Conditional expression (18) defines the focal length f4 of the fourth lens L4, enhancing the performance of the camera optical lens 10, 20, 30, 40, 50, or 60. Conditional expression (19) specifies the on-axis thickness d7 of the fourth lens L4, enabling control of the optical total track length TTL of the camera optical lens 10, 20, 30, 40, 50, or 60 to support miniaturization design.

A central curvature radius of the object side surface of the fifth lens L5 is denoted as R9, a central curvature radius of the image side surface of the fifth lens L5 is denoted as R10, an on-axis thickness of the fifth lens L5 is denoted as d9, and the camera optical lens satisfies the following:

$$- 0.39 \leq ( R 9 + R 10 ) / ( R 9 - R 10 ) \leq - 0.32 ; \qquad ( 20 )$$

$$4.32 \leq f 5 / f \leq 6.74 ; \qquad ( 21 )$$

$$0.09 \leq d 9 / TTL \leq 0.14 . \qquad ( 22 )$$

Conditional expression (20) specifies the shape of the fifth lens L5, which effectively corrects spherical aberration in the camera optical lens 10, 20, 30, 40, 50, or 60 to enhance imaging quality. Conditional expression (21) specifies the focal length f5 of the fifth lens L5, enhancing the performance of the camera optical lens 10, 20, 30, 40, 50, or 60. Conditional expression (22) specifies the on-axis thickness d9 of the fifth lens L5, reducing the optical total track length TTL of the camera optical lens 10, 20, 30, 40, 50, or 60.

A central curvature radius of the object side surface of the sixth lens L6 is denoted as R11, a central curvature radius of the image side surface of the sixth lens L6 is denoted as R12, a focal length of the sixth lens L6 is denoted as f6, an on-axis thickness of the sixth lens L6 is denoted as d11, and the camera optical lens satisfies the following:

$$3.04 \leq ( R 11 + R 12 ) / ( R 11 - R 12 ) \leq 3.52 ; \qquad ( 23 )$$

$$- 4.5 \leq f 6 / f \leq - 3.49 ; \qquad ( 24 )$$

$$0.01 \leq d 11 / TTL \leq 0.02 . \qquad ( 25 )$$

Conditional expression (23) specifies the shape of the sixth lens L6, which can alleviate the degree of light deflection through the second lens L6, effectively reducing aberrations. Conditional expression (24) specifies the focal length f6 of the sixth lens L6. Within this range, the sixth lens L6 possesses appropriate negative refractive power, facilitating aberration reduction. Conditional expression (25) specifies the on-axis thickness d11 of the sixth lens L6, reducing the optical total track length TTL of the camera optical lens 10, 20, 30, 40, 50, or 60 to achieve ultra-thin design.

A central curvature radius of the object side surface of the seventh lens L7 is denoted as R13, a central curvature radius of the image side surface of the seventh lens L7 is denoted as R14, a focal length of the seventh lens L7 is denoted as f7, an on-axis thickness of the seventh lens L7 is denoted as d13, and the camera optical lens satisfies the following:

$$- 0.51 \leq ( R 13 + R 14 ) / ( R 13 - R 14 ) \leq - 0.39 ; \qquad ( 26 )$$

$$1.87 \leq f 7 / f \leq 2.5 ; \qquad ( 27 )$$

$$0.03 \leq d 13 / TTL \leq 0.05 . \qquad ( 28 )$$

Conditional expression (26) specifies the shape of the seventh lens L7, which effectively corrects spherical aberration in the camera optical lens 10, 20, 30, 40, 50, or 60 to enhance imaging quality. Conditional expression (27) specifies the focal length f7 of the seventh lens L7, so that the seventh lens L7 possesses appropriate positive refractive power, effectively reducing aberrations. Conditional expression (28) specifies the on-axis thickness d13 of the seventh lens L7, facilitating control over the optical total track length TTL of the camera optical lens 10, 20, 30, 40, 50, or 60.

A central curvature radius of the object side surface of the eighth lens L8 is denoted as R15, a central curvature radius of the image side surface of the eighth lens L8 is denoted as R16, a focal length of the eighth lens L8 is denoted as f8, an on-axis thickness of the eighth lens L8 is denoted as d15, and the camera optical lens satisfies the following:

$$0.08 \leq ( R 15 + R 16 ) / ( R 15 - R 16 ) \leq 0.41 ; \qquad ( 29 )$$

$$- 3.2 \leq f 8 / f \leq 7.7 ; \qquad ( 30 )$$

$$0. \leq d 15 / TTL \leq 0.02 . \qquad ( 31 )$$

Conditional expression (29) specifies the shape of the eighth lens L8. Within this range, it enables rational control of the eighth lens L8's shape, which can alleviate the degree of light deflection through the eighth lens L8, to provide the camera optical lens 10, 20, 30, 40, 50, or 60 with superior imaging quality and reduced sensitivity. Conditional expression (30) specifies the focal length f8 of the eighth lens L8. Within this range, it enhances the optical performance of the camera optical lens 10, 20, 30, 40, 50, or 60. Conditional expression (30) specifies the on-axis thickness d15 of the eighth lens L8, reducing the optical total track length TTL of the camera optical lens 10, 20, 30, 40, 50, or 60 to achieve ultra-thin design.

A central curvature radius of the object side surface of the ninth lens L9 is denoted as R17, a central curvature radius of the image side surface of the ninth lens L9 is denoted as R18, a focal length of the ninth lens L9 is denoted as f9, an on-axis thickness of the ninth lens L9 is denoted as d17, and the camera optical lens satisfies the following:

$$- 0.95 \leq ( R 17 + R 18 ) / ( R 17 - R 18 ) \leq - 0.16 ; \qquad ( 32 )$$

$$- 3.3 \leq f 9 / f \leq 5.1 ; \qquad ( 33 )$$

$$0. \leq d 17 / TTL \leq 0.04 . \qquad ( 34 )$$

Conditional expression (32) specifies the shape of the ninth lens L9, which helps reduce spherical aberration in the camera optical lens 10, 20, 30, 40, 50, or 60, thereby improving imaging quality. Conditional expression (33) specifies the focal length f9 of the ninth lens L9, which can enhance the optical performance of the camera optical lens 10, 20, 30, 40, 50, or 60. Conditional expression (34) specifies the on-axis thickness d17 of the ninth lens L9, facilitating control over the optical total track length TTL of the camera optical lens 10, 20, 30, 40, 50, or 60.

In some embodiments, the field of view FOV at the 1.0 field of the camera optical lens 10, 20, 30, 40, 50, or 60 complies with the following:

$$109.4 ° \leq FOV \leq 126 ° \qquad ( 35 )$$

In some embodiments, the first lens L1, second lens L2, third lens L3, fourth lens L4, fifth lens L5, sixth lens L6, seventh lens L7, eighth lens L8, and ninth lens L9 are all made of glass. The lenses may also be made of other materials.

According to the present disclosure, the aperture stop ST of the camera optical lens 10, 20, 30, 40, 50, or 60 is not confined to being positioned between the fifth lens L5 and sixth lens L6, and may alternatively be located elsewhere. Additionally, the camera optical lens 10, 20, 30, 40, 50, or 60 may incorporate one or more optical elements such as an optical filter GF, which may be either a glass cover plate or an optical filter. For example, an optical filter may be placed on the image side of the ninth lens L9.

According to the solution of the present disclosure, the above configuration of the lenses provides a large-aperture, wide-angle, dual-channel optical lens 10, 20, 30, 40, 50, or 60 that exhibits excellent optical performance in both visible and infrared light bands. This lens controls the total optical length of the camera optical system, rationally allocates focal lengths of lenses, effectively mitigates temperature drift, moderates the deflection degree of light rays passing through lenses, efficiently corrects chromatic aberration, and enhances imaging performance.

The following examples illustrate the camera optical lens 10, 20, 30, 40, 50, or 60 according to the present disclosure. The symbols used in each example are listed in Table 1, with focal length, on-axis distance, curvature radius, central curvature radius, and on-axis thickness all sharing the unit of millimeters (mm).

TTL: total track length (the on-axis distance from the object side surface of the first lens L1 to the image plane Si), in millimeter;

F-number FNO: ratio of an effective focal length of the camera optical lens to an entrance pupil diameter of the camera optical lens;

IH at 1.0 field: field height corresponding to the sensor's effective image element (i.e., half the diagonal length of the senor's effective image element region);

FOV at 1.0 field: Field of view corresponding to the sensor's effective image element;

Preferably, the lens may also be provided with inflection points and/or arrest points on the object side surface and/or the image side surface to achieve high-quality imaging.

### First Embodiment

FIG. 1 is a schematic structural diagram of a camera optical lens 10 according to the first embodiment of the present disclosure. The following presents design data for the camera optical lens 10 according to the first embodiment of the present disclosure.

Table 1 lists the central curvature radius R of object side and image side surfaces, on-axis thickness of each lens, on-axis distance d between lenses, refractive index nd, and Abbe number vd for the first lens L1 through ninth lens L9 constituting the camera optical lens 10 in this first embodiment. It should be noted that all distances, radii, and thicknesses in this embodiment are specified in millimeters (mm).

TABLE 1

| | R | D | | nd | | vd | |
|---|---|---|---|---|---|---|---|
| R1 | 53.686 | d1= | 3.000 | nd1 | 1.8061 | νd1 | 40.73 |
| R2 | 9.129 | d2= | 5.873 | | | | |
| R3 | 20.802 | d3= | 1.163 | nd2 | 1.8061 | νd2 | 40.73 |
| R4 | 6.545 | d4= | 5.948 | | | | |
| R5 | −10.630 | d5= | 1.000 | nd3 | 1.7552 | νd3 | 27.55 |
| R6 | 13.063 | d6= | 0.694 | | | | |
| R7 | 19.704 | d7= | 12.005 | nd4 | 1.8052 | νd4 | 25.43 |
| R8 | −20.706 | d8= | 0.100 | | | | |
| R9 | 7.926 | d9= | 6.394 | nd5 | 1.4969 | νd5 | 81.52 |
| R10 | −16.169 | d10= | 5.466 | | | | |
| ST | ∞ | / | / | / | / | / | / |
| R11 | 5.500 | d11= | 0.500 | nd6 | 1.8052 | νd6 | 75.43 |
| R12 | 2.778 | d12= | 0.005 | | | | |
| R13 | 2.778 | d13= | 2.194 | nd7 | 1.4969 | vd7 | 81.52 |
| R14 | −6.355 | d14= | 0.080 | | | | |
| R15 | −11.73 | d15= | 0.550 | nd8 | 1.8052 | vd8 | 25.43 |
| R16 | 7.726 | d16= | 0.080 | | | | |
| R17 | 6.183 | d17= | 1.822 | nd9 | 1.4969 | vd9 | 81.52 |
| R18 | −14.092 | d18= | 0.500 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 1.716 | | | | |

Specific meanings of the symbols therein are listed as follow:
R: curvature radius of optical surfaces or central curvature radius of a lens's object side surface or image side surface;
ST: aperture stop;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the fifth lens L5;
R10: central curvature radius of the image side surface of the fifth lens L5;
R11: central curvature radius of the object side surface of the sixth lens L6;
R12: central curvature radius of the image side surface of the sixth lens L6;
R13: central curvature radius of the object side surface of the seventh lens L7;
R14: central curvature radius of the image side surface of the seventh lens L7;
R15: central curvature radius of the object side surface of the eighth lens L8;
R16: central curvature radius of the image side surface of the eighth lens L8;
R17: central curvature radius of the object side surface of the ninth lens L9;
R18: central curvature radius of the image side surface of the ninth lens L9;
R19: curvature radius of the object side surface of the first optical filter GF1;
R20: curvature radius of the image side surface of the first optical filter GF1;
R21: curvature radius of the object side surface of the second optical filter GF2;
R22: curvature radius of the image side surface of the second optical filter GF1;
d: on-axis thickness of the lens, or on-axis distance between the lenses;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the sixth lens L6;
d11: on-axis thickness of the sixth lens L6;
d12: on-axis distance from the image side surface of the sixth lens L6 to the object side surface of the seventh lens L7;
d13: on-axis thickness of the seventh lens L7;
d14: on-axis distance from the image side surface of the seventh lens L7 to the object side surface of the optical filter GF;
d15: on-axis thickness of the eighth lens L8;
d16: on-axis distance from the image side surface of the eighth lens L8 to the object side surface of the ninth lens L9;
d17: on-axis thickness of the ninth lens L9;
d18: on-axis distance from the image side surface of the ninth lens L9 to the object side surface of the first optical filter GF1;
d19: on-axis thickness of the first optical filter GF1;
d20: on-axis distance from the image side surface of the first optical filter GF1 to the object side surface of the second optical filter GF2;
d21: on-axis thickness of the second optical filter GF2;
d22: on-axis distance from the image side surface of the second optical filter GF2 to the image plane Si;
nd: refractive index of d-line (d-line is green light with wavelength of 555 nm);
nd1: refractive index at d-line of the first lens L1;
nd2: refractive index at d-line of the second lens L2;
nd3: refractive index at d-line of the third lens L3;
nd4: refractive index at d-line of the fourth lens L4;
nd5: refractive index at d-line of the fifth lens L5;
nd6: refractive index at d-line of the sixth lens L6;
nd7: refractive index at d-line of the seventh lens L7;
nd8: refractive index at d-line of the eighth lens L8;
nd9: refractive index at d-line of the ninth lens L9;
ndg1: refractive index at d-line of the first optical filter GF1;
ndg2: refractive index at d-line of the second optical filter GF2;
vd: Abbe number;
vd1: Abee number of the first lens L1;
vd2: Abee number of the second lens L2;
vd3: Abee number of the third lens L3;
vd4: Abee number of the fourth lens L4;
vd5: Abee number of the fifth lens L5;
vd6: Abee number of the sixth lens L6;
vd7: Abee number of the seventh lens L7;
vd8: Abee number of the eighth lens L8;
vd9: Abee number of the ninth lens L9;
vg1: Abee number of the first optical filter GF1;
vg2: Abee number of the second optical filter GF2.

TABLE 2

| | Conic constant | Aspheric coefficient | | | |
|---|---|---|---|---|---|
| | k | A4 | A6 | A8 | A10 |
| R1 | 7.7419E+00 | 7.8307E−05 | −3.0334E−07 | 7.4407E−10 | −8.2997E−13 |
| R2 | −1.4643E+00 | 6.5374E−05 | 1.8227E−06 | −2.2837E−08 | 6.4763E−11 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −4.8656E−01 | −1.2761E−04 | −9.1433E−07 | −2.9368E−09 | −1.6377E−10 |
| R10 | −4.4211E−01 | 2.7186E−04 | −4.3581E−06 | 4.9232E−08 | −3.2966E−10 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | 6.3366E−01 | −3.3334E−03 | −1.1819E−05 | 4.8037E−05 | −9.9900E−08 |
| R18 | −1.0000E+02 | −5.4061E−03 | 6.3564E−04 | −1.0360E−04 | 9.7293E−06 |

It should be noted that the aspheric surfaces of each lens in this embodiment are defined by the following conditional expression (36). However, the specific form of conditional expression (36) serves only as an example. In practice, the present disclosure is not limited to the aspheric polynomial form represented by conditional expression (36).

$$z = ( {c}^{2} / r ) / \{ 1 + {[ 1 - ( k + 1 ) ( {c}^{2} / {r}^{2} ) ]}^{1 / 2} \} + A 4 {c}^{4} + A 6 {c}^{6} + A 8 {c}^{8} + A 10 {c}^{10} \qquad ( 36 )$$

where, k represents conic constant, A₄, A₆, A₈, and A₁₀ represent aspheric coefficients, where c denotes a curvature at the center of the optical surface, r denotes a vertical distance between a point on the aspherical curve and the optical axis, z denotes a depth of the aspherical surface (the vertical distance between a point on the aspherical surface with a distance of r from the optical axis and a tangent plane tangential to the vertex on the optical axis of the aspherical surface).

Additionally, Table 15 provided hereafter lists values corresponding to various parameters in the first embodiment and parameters specified in the conditional expressions.

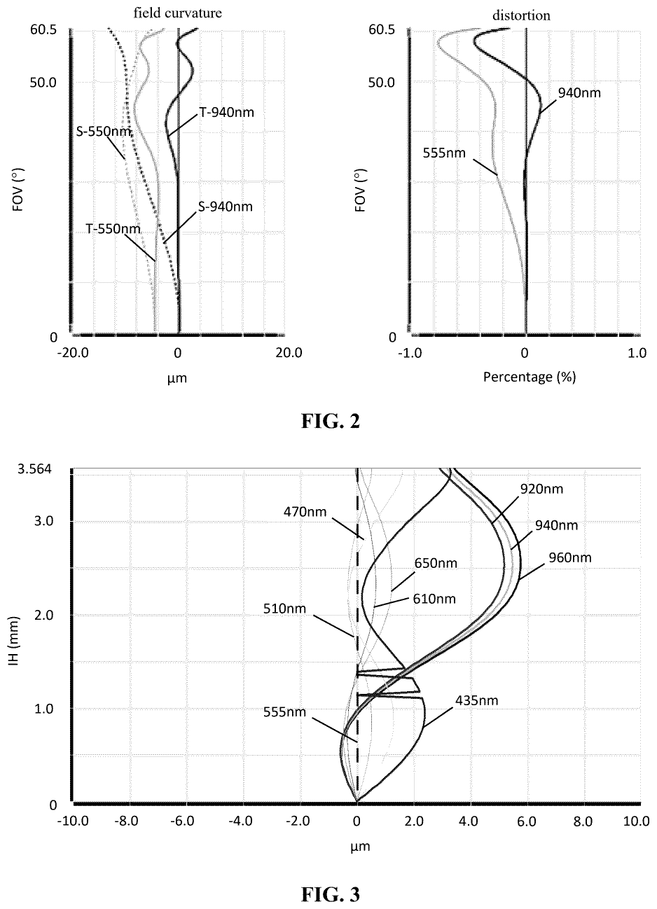

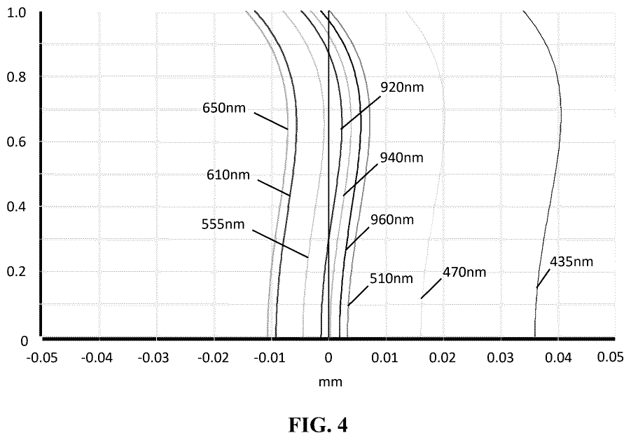

FIG. 2 illustrates field curvature and distortion diagrams of the camera optical lens 10 according to the first embodiment under light wavelengths of 555 nm and 940 nm. In FIG. 2, S denotes sagittal field curvature, and T denotes meridional field curvature. FIG. 3 illustrates magnification chromatic aberration diagrams of the camera optical lens 10 according to the first embodiment under light wavelengths of 435 nm, 470 nm, 510 nm, 555 nm, 610 nm, 650 nm, 920 nm, 940 nm, and 960 nm. FIG. 4 illustrates longitudinal aberration diagrams of the camera optical lens 10 according to the first embodiment under light wavelengths of 435 nm, 470 nm, 510 nm, 555 nm, 610 nm, 650 nm, 920 nm, 940 nm, and 960 nm.

As shown in Table 15, the first embodiment satisfies all conditional expression al expressions.

In this embodiment, the entrance pupil diameter of the camera optical lens 10 is 0.831 mm, the IH at 1.0 field is 3.564 mm, and the field of view FOV at 1.0 field is 121.04°. The camera optical lens 10 fulfills the design requirements of large aperture and wide-angle characteristics while maintaining excellent optical performance across both visible and infrared light bands. Its on-axis and off-axis chromatic aberrations are adequately corrected, exhibiting superior optical performance.

### Second Embodiment

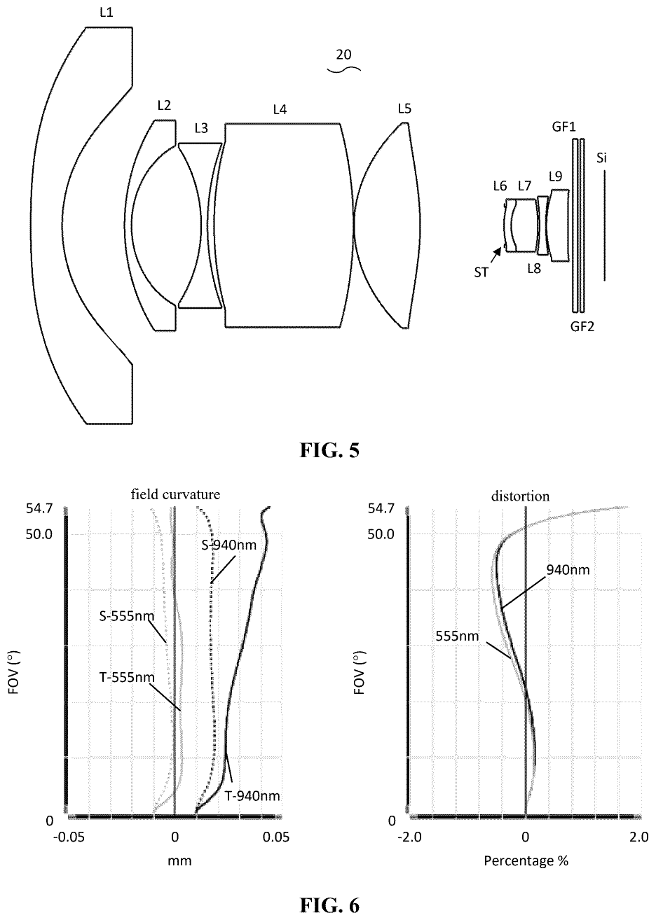

FIG. 5 is a schematic diagram of the camera optical lens 20 according to the second embodiment. The second embodiment is substantially identical to the first embodiment, with symbol meanings consistent with those of the first embodiment. Only differences are listed hereafter.

Tables 3 and 4 show design data of the camera optical lens 20 according to the second embodiment of the present disclosure.

TABLE 3

| | R | D | | nd | | vd | |
|---|---|---|---|---|---|---|---|
| R1 | 48.879 | d1= | 2.500 | nd1 | 1.8061 | νd1 | 40.73 |
| R2 | 9.115 | d2= | 4.960 | | | | |
| R3 | 12.266 | d3= | 0.550 | nd2 | 1.8061 | νd2 | 40.73 |
| R4 | 6.121 | d4= | 5.538 | | | | |
| R5 | −9.035 | d5= | 0.500 | nd3 | 1.7552 | νd3 | 27.55 |
| R6 | 14.543 | d6= | 0.526 | | | | |
| R7 | 19.529 | d7= | 11.069 | nd4 | 1.8052 | νd4 | 25.43 |
| R8 | −23.615 | d8= | 0.050 | | | | |
| R9 | 7.128 | d9= | 4.250 | nd5 | 1.4969 | νd5 | 81.52 |
| R10 | −16.076 | d10= | 6.668 | | | | |
| ST | ∞ | / | / | / | / | / | / |
| R11 | 5.119 | d11= | 0.563 | nd6 | 1.8052 | νd6 | 75.43 |
| R12 | 2.853 | d12= | 0.005 | | | | |
| R13 | 2.853 | d13= | 2.122 | nd7 | 1.4969 | vd7 | 81.52 |
| R14 | −8.644 | d14= | 0.126 | | | | |
| R15 | −12.385 | d15= | 0.502 | nd8 | 1.8052 | vd8 | 25.43 |
| R16 | 10.435 | d16= | 0.050 | | | | |
| R17 | 6.330 | d17= | 1.704 | nd9 | 1.4969 | vd9 | 81.52 |
| R18 | −235.503 | d18= | 0.383 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 1.618 | | | | |

TABLE 4

| | Conic constant | Aspheric coefficient | | | |
|---|---|---|---|---|---|
| | k | A4 | A6 | A8 | A10 |
| R1 | 7.3629E+00 | 1.3891E−04 | −7.8926E−07 | 2.5767E−09 | −3.7498E−12 |
| R2 | −1.3719E+00 | 1.4759E−04 | 3.1112E−06 | −5.4802E−08 | 1.8106E−10 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −5.1622E−01 | −1.2499E−04 | 5.5994E−07 | −1.0706E−08 | 1.2885E−10 |
| R10 | −1.0943E+00 | 3.4125E−04 | −3.2878E−06 | 3.2689E−08 | −1.3763E−10 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | 2.5238E+00 | −2.2613E−03 | 4.4318E−05 | 3.2174E−05 | −1.8567E−06 |
| R18 | −6.9084E+06 | 1.1393E−03 | 2.6954E−05 | 2.2329E−05 | 1.8675E−06 |

Additionally, Table 15 provided hereafter lists values corresponding to various parameters in the second embodiment and parameters specified in the conditional expressions.

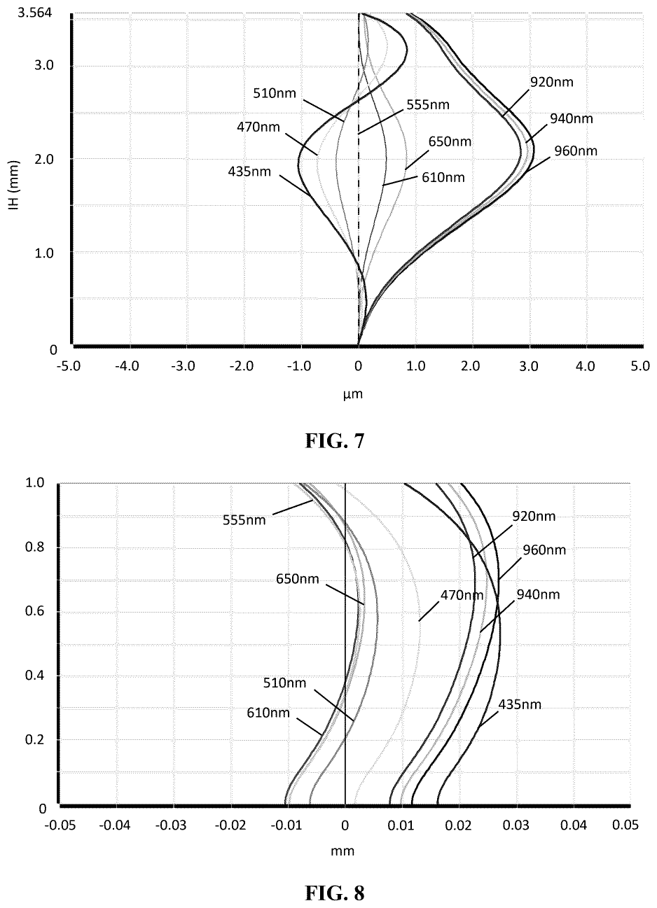

FIG. 6 illustrates field curvature and distortion diagrams of the camera optical lens 20 according to the second embodiment under light wavelengths of 555 nm and 940 nm. In FIG. 6, S denotes sagittal field curvature, and T denotes meridional field curvature. FIG. 7 illustrates magnification chromatic aberration diagrams of the camera optical lens 20 according to the second embodiment under light wavelengths of 435 nm, 470 nm, 510 nm, 555 nm, 610 nm, 650 nm, 920 nm, 940 nm, and 960 nm. FIG. 8 illustrates longitudinal aberration diagrams of the camera optical lens 20 according to the second embodiment under light wavelengths of 435 nm, 470 nm, 510 nm, 555 nm, 610 nm, 650 nm, 920 nm, 940 nm, and 960 nm.

As shown in Table 15, the second embodiment satisfies all conditional expression al expressions.

In this embodiment, the entrance pupil diameter of the camera optical lens 20 is 1.018 mm, the IH at 1.0 field is 3.564 mm, and the field of view FOV at 1.0 field is 109.41°. The camera optical lens 20 fulfills the design requirements of large aperture and wide-angle characteristics while maintaining excellent optical performance across both visible and infrared light bands. Its on-axis and off-axis chromatic aberrations are adequately corrected, exhibiting superior optical performance.

### Third Embodiment

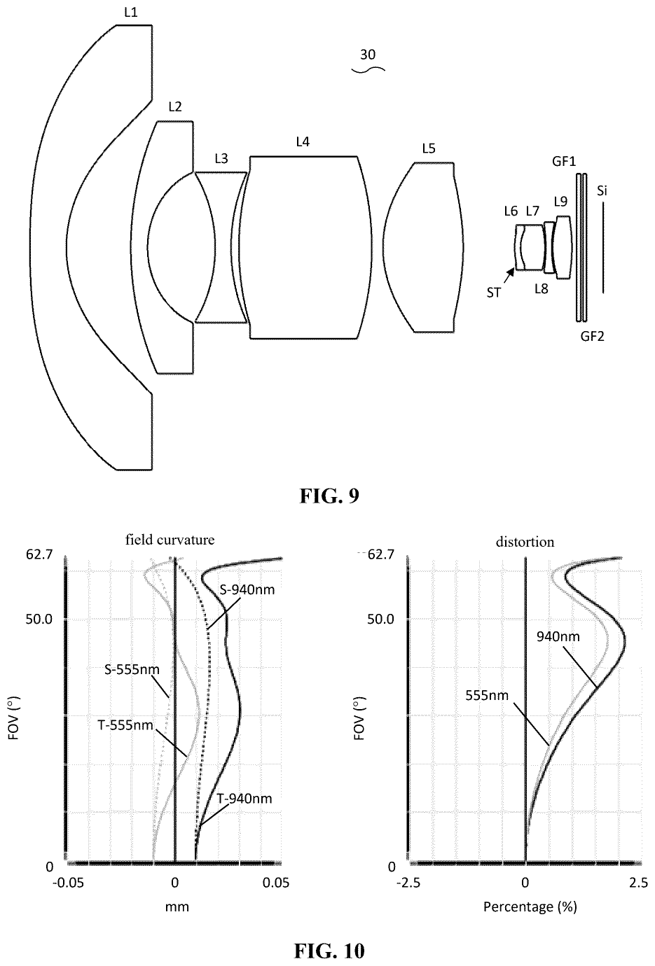

FIG. 9 is a schematic diagram of the camera optical lens 30 according to the third embodiment. The third embodiment is substantially identical to the first embodiment, with symbol meanings consistent with those of the first embodiment. Only differences are listed hereafter.

In this embodiment, the eighth lens L8 possesses a positive refractive power, and the ninth lens L9 possesses a negative refractive power.

Tables 5 and 6 show design data of the camera optical lens 30 according to the third embodiment of the present disclosure.

TABLE 5

| | R | D | | nd | | vd | |
|---|---|---|---|---|---|---|---|
| R1 | 54.850 | d1= | 3.360 | nd1 | 1.8061 | νd1 | 40.73 |
| R2 | 9.167 | d2= | 5.949 | | | | |
| R3 | 22.717 | d3= | 1.546 | nd2 | 1.8061 | νd2 | 40.73 |
| R4 | 6.560 | d4= | 6.238 | | | | |
| R5 | −10.670 | d5= | 1.464 | nd3 | 1.7552 | νd3 | 27.55 |
| R6 | 13.273 | d6= | 0.722 | | | | |
| R7 | 19.592 | d7= | 12.268 | nd4 | 1.8052 | νd4 | 25.43 |
| R8 | −20.671 | d8= | 1.023 | | | | |
| R9 | 8.031 | d9= | 7.402 | nd5 | 1.4969 | νd5 | 81.52 |
| R10 | −15.858 | d10= | 4.750 | | | | |
| ST | ∞ | / | / | / | / | / | / |
| R11 | 5.515 | d11= | 0.540 | nd6 | 1.8052 | νd6 | 75.43 |
| R12 | 2.840 | d12= | 0.005 | | | | |
| R13 | 2.840 | d13= | 2.247 | nd7 | 1.4969 | vd7 | 81.52 |
| R14 | −6.670 | d14= | 0.074 | | | | |
| R15 | −12.277 | d15= | 0.551 | nd8 | 1.8052 | vd8 | 25.43 |
| R16 | 7.829 | d16= | 0.091 | | | | |
| R17 | 6.543 | d17= | 1.773 | nd9 | 1.4969 | vd9 | 81.52 |
| R18 | −12.101 | d18= | 0.416 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 1.566 | | | | |

TABLE 6

| | Conic constant | Aspheric coefficient | | | |
|---|---|---|---|---|---|
| | k | A4 | A6 | A8 | A10 |
| R1 | 7.6070E+00 | 7.8861E−05 | −2.9880E−07 | 6.7252E−10 | −6.3909E−13 |
| R2 | −1.4128E+00 | 5.6775E−05 | 1.9686E−06 | −2.2851E−08 | 6.3516E−11 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −4.7479E−01 | −1.2368E−04 | −2.3117E−08 | −2.1983E−08 | −7.4926E−12 |
| R10 | −5.6372E−01 | 3.1172E−04 | −4.6537E−06 | 1.7261E−08 | 3.0823E−10 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | 1.9325E+00 | −3.2444E−03 | 1.5278E−04 | 5.7133E−05 | −1.9011E−06 |
| R18 | −1.3335E+02 | −6.5363E−03 | 1.1238E−03 | −1.3435E−04 | 1.4358E−05 |

Additionally, Table 15 provided hereafter lists values corresponding to various parameters in the third embodiment and parameters specified in the conditional expressions.

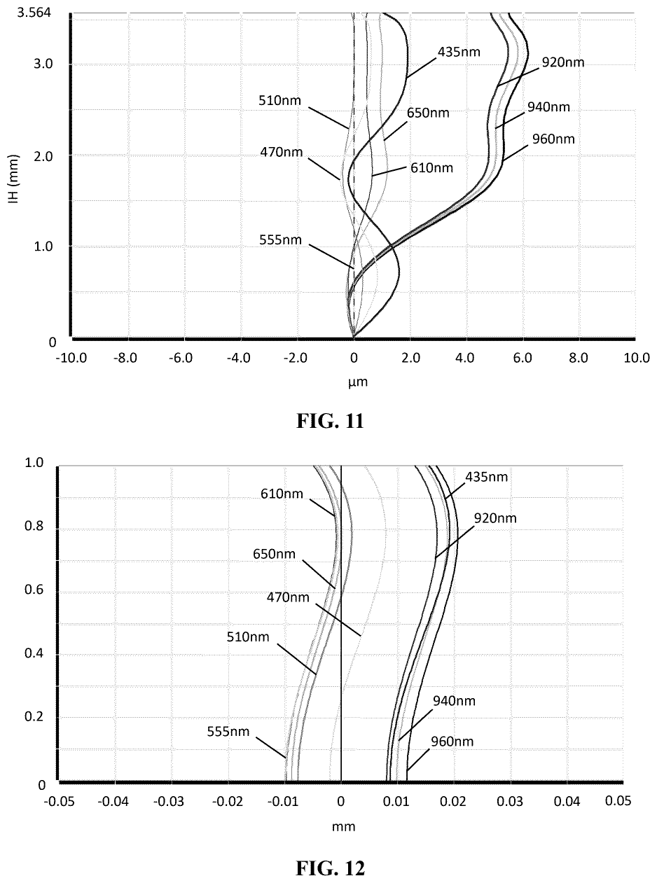

FIG. 10 illustrates field curvature and distortion diagrams of the camera optical lens 30 according to the third embodiment under light wavelengths of 555 nm and 940 nm. In FIG. 10, S denotes sagittal field curvature, and T denotes meridional field curvature. FIG. 11 illustrates magnification chromatic aberration diagrams of the camera optical lens 30 according to the third embodiment under light wavelengths of 435 nm, 470 nm, 510 nm, 555 nm, 610 nm, 650 nm, 920 nm, 940 nm, and 960 nm. FIG. 12 illustrates longitudinal aberration diagrams of the camera optical lens 30 according to the third embodiment under light wavelengths of 435 nm, 470 nm, 510 nm, 555 nm, 610 nm, 650 nm, 920 nm, 940 nm, and 960 nm.

As shown in Table 15, the third embodiment satisfies all conditional expression al expressions.

In this embodiment, the entrance pupil diameter of the camera optical lens 30 is 0.738 mm, the IH at 1.0 field is 3.564 mm, and the field of view FOV at 1.0 field is 125.45°. The camera optical lens 30 fulfills the design requirements of large aperture and wide-angle characteristics while maintaining excellent optical performance across both visible and infrared light bands. Its on-axis and off-axis chromatic aberrations are adequately corrected, exhibiting superior optical performance.

### Fourth Embodiment

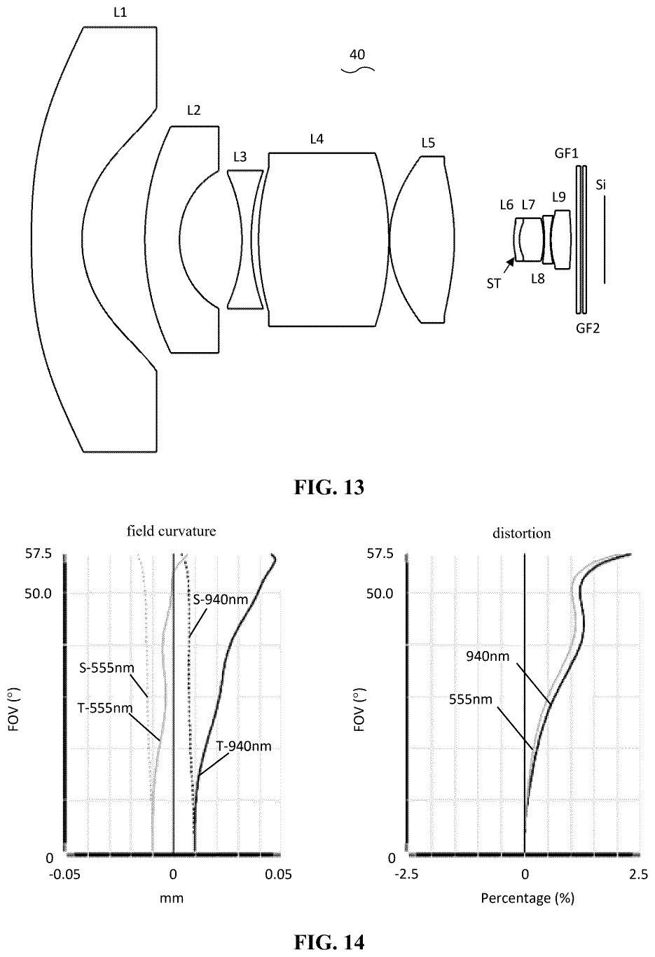

FIG. 13 is a schematic diagram of the camera optical lens 40 according to the fourth embodiment. The fourth embodiment is substantially identical to the first embodiment, with symbol meanings consistent with those of the first embodiment. Only differences are listed hereafter.

Tables 7 and 8 show design data of the camera optical lens 40 according to the fourth embodiment of the present disclosure.

TABLE 7

| | R | D | | nd | | vd | |
|---|---|---|---|---|---|---|---|
| R1 | 59.270 | d1= | 4.615 | nd1 | 1.7174 | νd1 | 40.73 |
| R2 | 8.646 | d2= | 5.738 | | | | |
| R3 | 18.933 | d3= | 3.159 | nd2 | 1.8061 | νd2 | 40.73 |
| R4 | 6.118 | d4= | 5.695 | | | | |
| R5 | −11.486 | d5= | 0.842 | nd3 | 1.7552 | νd3 | 27.55 |
| R6 | 14.649 | d6= | 0.674 | | | | |
| R7 | 18.823 | d7= | 11.886 | nd4 | 1.8052 | νd4 | 25.43 |
| R8 | −20.372 | d8= | 0.068 | | | | |
| R9 | 7.986 | d9= | 5.908 | nd5 | 1.4969 | νd5 | 81.52 |
| R10 | −15.938 | d10= | 5.418 | | | | |
| ST | ∞ | / | / | / | / | / | / |
| R11 | 5.502 | d11= | 0.513 | nd6 | 1.8052 | νd6 | 75.43 |
| R12 | 2.791 | d12= | 0.005 | | | | |
| R13 | 2.791 | d13= | 2.199 | nd7 | 1.4969 | vd7 | 81.52 |
| R14 | −6.413 | d14= | 0.077 | | | | |
| R15 | −10.734 | d15= | 0.547 | nd8 | 1.8052 | vd8 | 25.43 |
| R16 | 7.787 | d16= | 0.051 | | | | |
| R17 | 6.219 | d17= | 1.822 | nd9 | 1.4969 | vd9 | 81.52 |
| R18 | −17.955 | d18= | 0.480 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 1.681 | | | | |

TABLE 8

| | Conic constant | Aspheric coefficient | | | |
|---|---|---|---|---|---|
| | k | A4 | A6 | A8 | A10 |
| R1 | 6.8402E+00 | 8.0401E−05 | −4.0080E−07 | 9.7284E−10 | −1.1180E−12 |
| R2 | −1.2970E+00 | 1.7373E−04 | 2.1696E−06 | −4.5381E−08 | 1.5796E−10 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −4.5445E−01 | −1.0660E−04 | −5.8988E−07 | −1.6876E−08 | 4.6157E−11 |
| R10 | −8.6972E−01 | 3.2780E−04 | −6.1613E−06 | 8.8156E−08 | −5.7712E−10 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | 2.3402E+00 | −3.3736E−03 | 3.2697E−04 | 6.0617E−05 | −5.2409E−06 |
| R18 | −1.6636E+02 | −3.3948E−03 | 7.0411E−04 | −3.4417E−05 | 7.7745E−06 |

Additionally, Table 15 provided hereafter lists values corresponding to various parameters in the fourth embodiment and parameters specified in the conditional expressions.

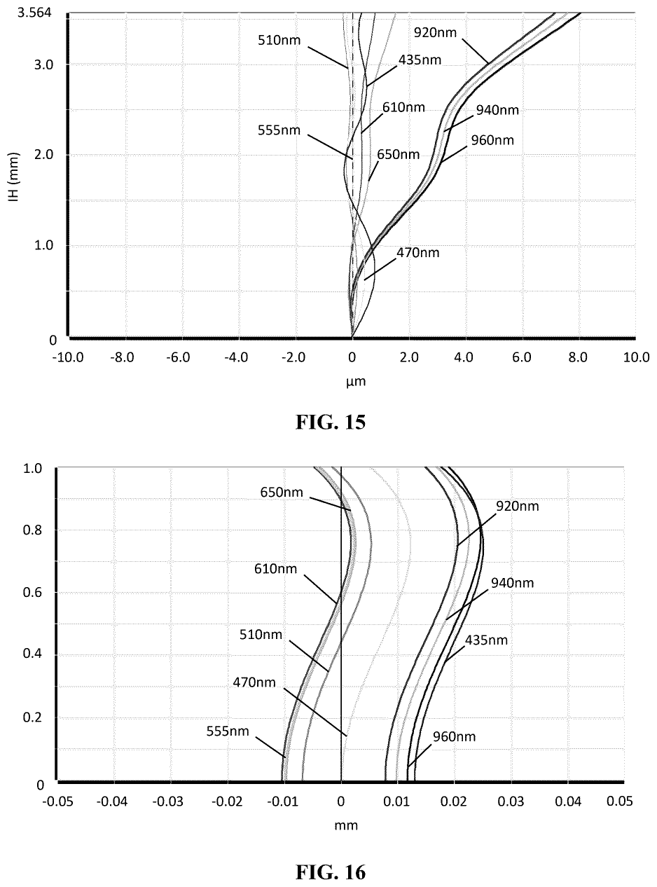

FIG. 14 illustrates field curvature and distortion diagrams of the camera optical lens 40 according to the fourth embodiment under light wavelengths of 555 nm and 940 nm. In FIG. 14, S denotes sagittal field curvature, and T denotes meridional field curvature. FIG. 15 illustrates magnification chromatic aberration diagrams of the camera optical lens 40 according to the fourth embodiment under light wavelengths of 435 nm, 470 nm, 510 nm, 555 nm, 610 nm, 650 nm, 920 nm, 940 nm, and 960 nm. FIG. 16 illustrates longitudinal aberration diagrams of the camera optical lens 40 according to the fourth embodiment under light wavelengths of 435 nm, 470 nm, 510 nm, 555 nm, 610 nm, 650 nm, 920 nm, 940 nm, and 960 nm.

As shown in Table 15, the fourth embodiment satisfies all conditional expression al expressions.

In this embodiment, the entrance pupil diameter of the camera optical lens 40 is 0.917 mm, the IH at 1.0 field is 3.564 mm, and the field of view FOV at 1.0 field is 115.00°. The camera optical lens 40 fulfills the design requirements of large aperture and wide-angle characteristics while maintaining excellent optical performance across both visible and infrared light bands. Its on-axis and off-axis chromatic aberrations are adequately corrected, exhibiting superior optical performance.

### Fifth Embodiment

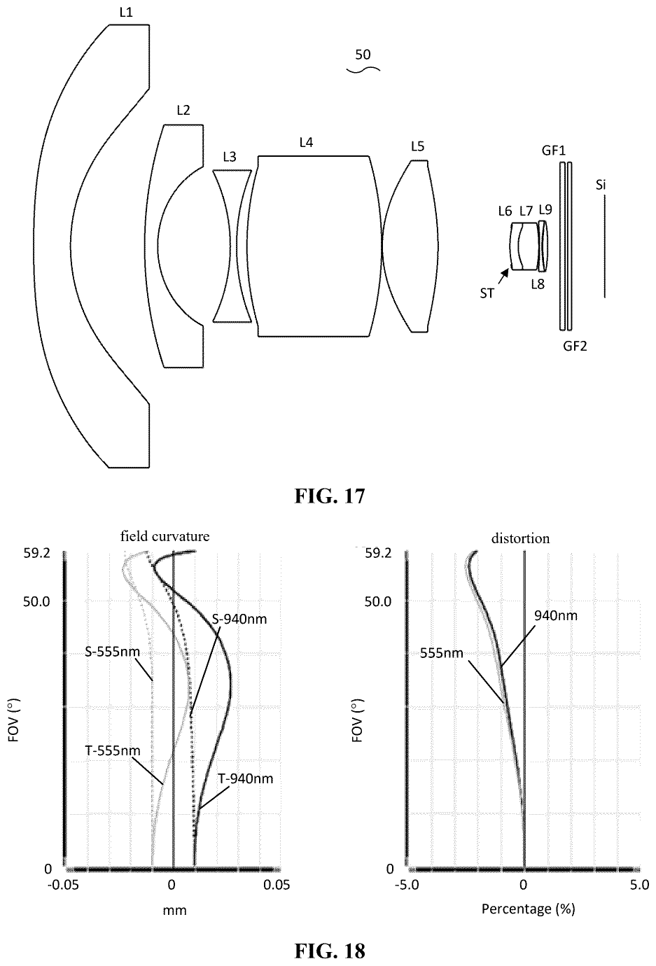

FIG. 17 is a schematic diagram of the camera optical lens 50 according to the fifth embodiment. The fifth embodiment is substantially identical to the first embodiment, with symbol meanings consistent with those of the first embodiment. Only differences are listed hereafter.

Tables 9 and 10 show design data of the camera optical lens 50 according to the fifth embodiment of the present disclosure.

TABLE 9

| | R | D | | nd | | vd | |
|---|---|---|---|---|---|---|---|
| R1 | 51.614 | d1= | 2.947 | nd1 | 1.7174 | νd1 | 40.73 |
| R2 | 10.990 | d2= | 5.908 | | | | |
| R3 | 25.078 | d3= | 1.040 | nd2 | 1.8061 | νd2 | 40.73 |
| R4 | 6.278 | d4= | 5.790 | | | | |
| R5 | −11.022 | d5= | 0.500 | nd3 | 1.7552 | νd3 | 27.55 |
| R6 | 12.806 | d6= | 0.828 | | | | |
| R7 | 18.772 | d7= | 10.741 | nd4 | 1.8052 | νd4 | 25.43 |
| R8 | −20.888 | d8= | 0.050 | | | | |
| R9 | 7.787 | d9= | 4.443 | nd5 | 1.4969 | νd5 | 81.52 |
| R10 | −16.431 | d10= | 5.730 | | | | |
| ST | ∞ | / | / | / | / | / | / |
| R11 | 5.576 | d11= | 0.662 | nd6 | 1.8052 | νd6 | 75.43 |
| R12 | 2.981 | d12= | 0.005 | | | | |
| R13 | 2.981 | d13= | 1.645 | nd7 | 1.4969 | vd7 | 81.52 |
| R14 | −8.011 | d14= | 0.050 | | | | |
| R15 | −18.788 | d15= | 0.204 | nd8 | 1.8052 | vd8 | 25.43 |
| R16 | 7.916 | d16= | 0.050 | | | | |
| R17 | 8.772 | d17= | 0.400 | nd9 | 1.4969 | vd9 | 81.52 |
| R18 | −12.270 | d18= | 0.977 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 2.662 | | | | |

TABLE 10

| | Conic constant | Aspheric coefficient | | | |
|---|---|---|---|---|---|
| | k | A4 | A6 | A8 | A10 |
| R1 | 8.2318E+00 | 1.0676E−04 | −4.9576E−07 | 1.3765E−09 | −1.8802E−12 |
| R2 | −1.4317E+00 | 1.1620E−04 | 1.5160E−06 | −2.6860E−08 | 9.2129E−11 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −5.4701E−01 | −1.6685E−04 | −5.2501E−07 | 9.2627E−09 | −6.1353E−10 |
| R10 | −5.2719E−01 | 2.3628E−04 | −1.2390E−06 | −3.0899E−08 | 3.2353E−10 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | −8.1965E+00 | −1.6124E−03 | −1.9769E−03 | 5.3581E−04 | −5.6365E−05 |
| R18 | −1.2973E+02 | −8.3803E−03 | 5.1528E−06 | −1.4372E−09 | 1.4377E−13 |

Additionally, Table 15 provided hereafter lists values corresponding to various parameters in the fifth embodiment and parameters specified in the conditional expressions.

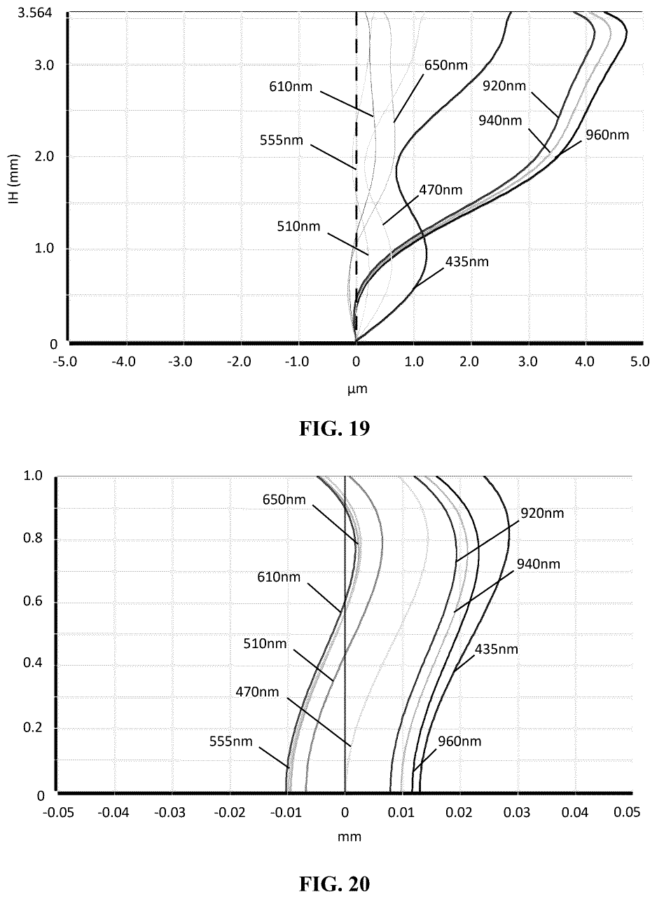

FIG. 18 illustrates field curvature and distortion diagrams of the camera optical lens 50 according to the fifth embodiment under light wavelengths of 555 nm and 940 nm. In FIG. 18, S denotes sagittal field curvature, and T denotes meridional field curvature. FIG. 19 illustrates magnification chromatic aberration diagrams of the camera optical lens 50 according to the fifth embodiment under light wavelengths of 435 nm, 470 nm, 510 nm, 555 nm, 610 nm, 650 nm, 920 nm, 940 nm, and 960 nm. FIG. 20 illustrates longitudinal aberration diagrams of the camera optical lens 50 according to the fifth embodiment under light wavelengths of 435 nm, 470 nm, 510 nm, 555 nm, 610 nm, 650 nm, 920 nm, 940 nm, and 960 nm.

As shown in Table 15, the fifth embodiment satisfies all conditional expression al expressions.

In this embodiment, the entrance pupil diameter of the camera optical lens 50 is 0.892 mm, the IH at 1.0 field is 3.564 mm, and the field of view FOV at 1.0 field is 118.50°. The camera optical lens 50 fulfills the design requirements of large aperture and wide-angle characteristics while maintaining excellent optical performance across both visible and infrared light bands. Its on-axis and off-axis chromatic aberrations are adequately corrected, exhibiting superior optical performance.

### Sixth Embodiment

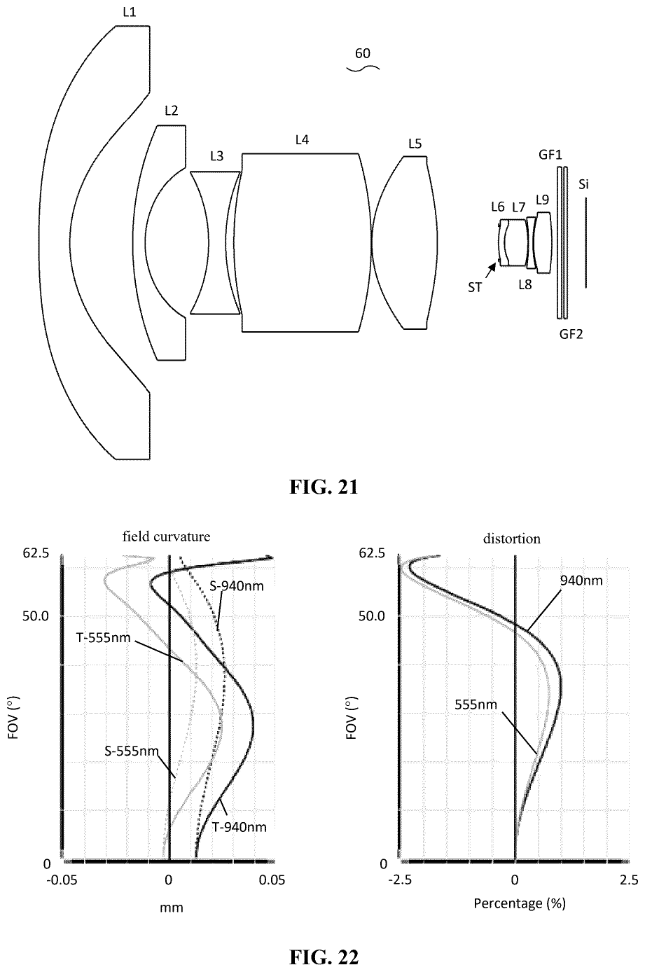

FIG. 21 is a schematic diagram of the camera optical lens 60 according to the sixth embodiment. The sixth embodiment is substantially identical to the first embodiment, with symbol meanings consistent with those of the first embodiment. Only differences are listed hereafter.

Tables 11 and 12 show design data of the camera optical lens 60 according to the sixth embodiment of the present disclosure.

TABLE 11

| | R | D | | nd | | vd | |
|---|---|---|---|---|---|---|---|
| R1 | 53.627 | d1= | 2.868 | nd1 | 1.8061 | νd1 | 40.73 |
| R2 | 9.430 | d2= | 5.816 | | | | |
| R3 | 20.038 | d3= | 1.149 | nd2 | 1.8061 | νd2 | 40.73 |
| R4 | 6.587 | d4= | 5.881 | | | | |
| R5 | −9.950 | d5= | 1.576 | nd3 | 1.7552 | νd3 | 27.55 |
| R6 | 12.323 | d6= | 0.757 | | | | |
| R7 | 21.699 | d7= | 12.718 | nd4 | 1.8052 | νd4 | 25.43 |
| R8 | −21.468 | d8= | 0.050 | | | | |
| R9 | 7.899 | d9= | 6.070 | nd5 | 1.4969 | νd5 | 81.52 |
| R10 | −16.074 | d10= | 5.653 | | | | |
| ST | ∞ | / | / | / | / | / | / |
| R11 | 5.495 | d11= | 0.546 | nd6 | 1.8052 | νd6 | 75.43 |
| R12 | 2.861 | d12= | 0.005 | | | | |
| R13 | 2.861 | d13= | 2.173 | nd7 | 1.4969 | vd7 | 81.52 |
| R14 | −6.678 | d14= | 0.050 | | | | |
| R15 | −12.004 | d15= | 0.413 | nd8 | 1.8052 | vd8 | 25.43 |
| R16 | 7.659 | d16= | 0.057 | | | | |
| R17 | 6.348 | d17= | 1.689 | nd9 | 1.4969 | vd9 | 81.52 |
| R18 | −13.491 | d18= | 0.520 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 1.750 | | | | |

TABLE 12

| | Conic constant | Aspheric coefficient | | | |
|---|---|---|---|---|---|
| | k | A4 | A6 | A8 | A10 |
| R1 | 7.7216E+00 | 8.8008E−05 | −3.6489E−07 | 9.2529E−10 | −1.0209E−12 |
| R2 | −1.4726E+00 | 4.3655E−05 | 2.3502E−06 | −2.6620E−08 | 7.1839E−11 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −4.7397E−01 | −1.4445E−04 | 2.0866E−07 | −1.4304E−08 | −1.0523E−10 |
| R10 | −4.4045E−01 | 2.1875E−04 | −2.3078E−08 | −6.5064E−08 | 7.7676E−10 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | 1.7395E+00 | −3.3680E−03 | 3.5001E−04 | −6.8801E−06 | 4.5945E−06 |
| R18 | −2.7550E+02 | −8.4086E−03 | 1.9847E−03 | −2.7913E−04 | 2.3484E−05 |

Additionally, Table 15 provided hereafter lists values corresponding to various parameters in the sixth embodiment and parameters specified in the conditional expressions.

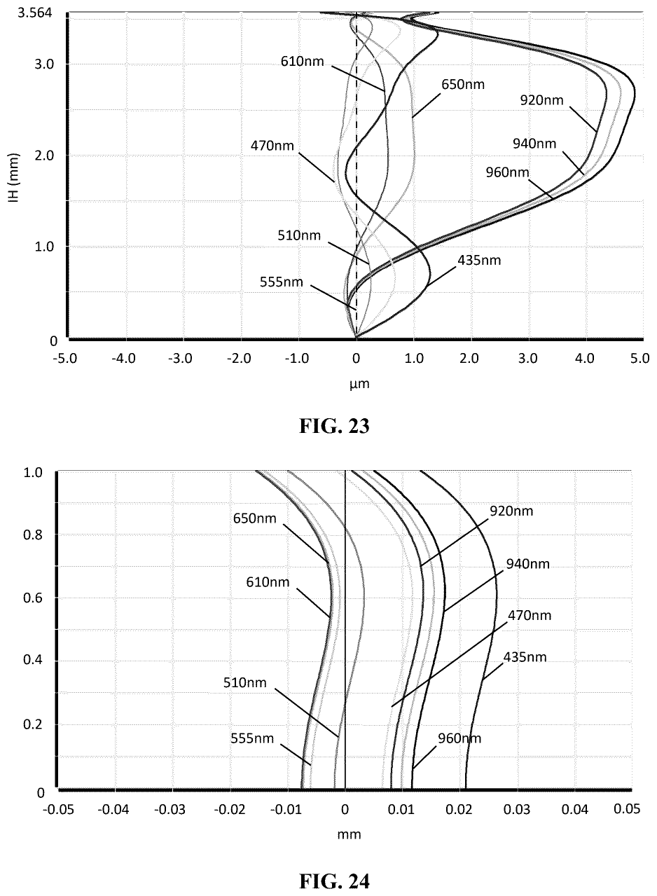

FIG. 22 illustrates field curvature and distortion diagrams of the camera optical lens 60 according to the sixth embodiment under light wavelengths of 555 nm and 940 nm. In FIG. 22, S denotes sagittal field curvature, and T denotes meridional field curvature. FIG. 23 illustrates magnification chromatic aberration diagrams of the camera optical lens 60 according to the sixth embodiment under light wavelengths of 435 nm, 470 nm, 510 nm, 555 nm, 610 nm, 650 nm, 920 nm, 940 nm, and 960 nm. FIG. 24 illustrates longitudinal aberration diagrams of the camera optical lens 60 according to the sixth embodiment under light wavelengths of 435 nm, 470 nm, 510 nm, 555 nm, 610 nm, 650 nm, 920 nm, 940 nm, and 960 nm.

As shown in Table 15, the sixth embodiment satisfies all conditional expression al expressions.

In this embodiment, the entrance pupil diameter of the camera optical lens 60 is 0.774 mm, the IH at 1.0 field is 3.564 mm, and the field of view FOV at 1.0 field is 124.97°. The camera optical lens 60 fulfills the design requirements of large aperture and wide-angle characteristics while maintaining excellent optical performance across both visible and infrared light bands. Its on-axis and off-axis chromatic aberrations are adequately corrected, exhibiting superior optical performance.

### Comparative Embodiment

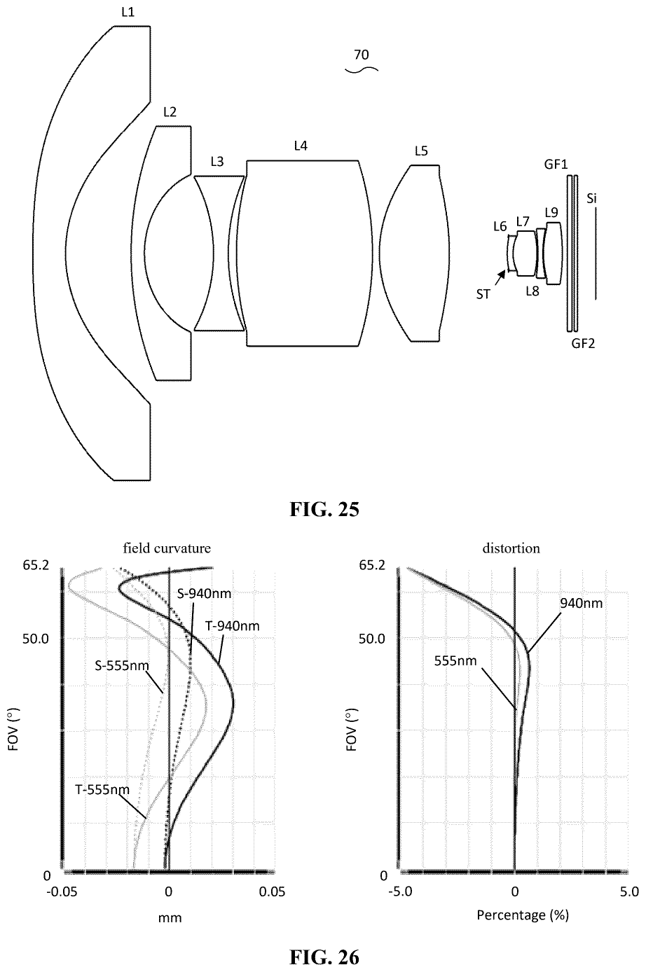

FIG. 25 is a schematic diagram of the camera optical lens 70 according to the comparative embodiment. The symbols in the comparative embodiment have the same meaning as those of the first embodiment. Only differences are listed hereafter.

Tables 13 and 14 show design data of the camera optical lens 70 according to the comparative embodiment of the present disclosure.

TABLE 13

| | R | D | | nd | | vd | |
|---|---|---|---|---|---|---|---|
| R1 | 54.055 | d1= | 2.946 | nd1 | 1.8061 | νd1 | 40.73 |
| R2 | 8.863 | d2= | 5.894 | | | | |
| R3 | 22.255 | d3= | 1.199 | nd2 | 1.8061 | νd2 | 40.73 |
| R4 | 6.489 | d4= | 6.210 | | | | |
| R5 | −10.734 | d5= | 1.329 | nd3 | 1.7552 | νd3 | 27.55 |
| R6 | 12.768 | d6= | 0.735 | | | | |
| R7 | 20.014 | d7= | 12.230 | nd4 | 1.8052 | νd4 | 25.43 |
| R8 | −20.402 | d8= | 0.618 | | | | |
| R9 | 8.049 | d9= | 6.289 | nd5 | 1.4969 | νd5 | 81.52 |
| R10 | −15.843 | d10= | 5.205 | | | | |
| ST | ∞ | / | / | / | / | / | / |
| R11 | 5.426 | d11= | 0.520 | nd6 | 1.8052 | νd6 | 75.43 |
| R12 | 2.777 | d12= | 0.005 | | | | |
| R13 | 2.777 | d13= | 2.150 | nd7 | 1.4969 | vd7 | 81.52 |
| R14 | −6.296 | d14= | 0.078 | | | | |
| R15 | −12.298 | d15= | 0.450 | nd8 | 1.8052 | vd8 | 25.43 |
| R16 | 7.595 | d16= | 0.050 | | | | |
| R17 | 6.116 | d17= | 1.699 | nd9 | 1.4969 | vd9 | 81.52 |
| R18 | −12.838 | d18= | 0.462 | | | | |
| R19 | ∞ | d19= | 0.400 | ndg1 | 1.5168 | vg1 | 64.17 |
| R20 | ∞ | d20= | 0.211 | | | | |
| R21 | ∞ | d21= | 0.300 | ndg2 | 1.5168 | vg2 | 64.17 |
| R22 | ∞ | d22= | 1.639 | | | | |

TABLE 14

| | Conic constant | Aspheric coefficient | | | |
|---|---|---|---|---|---|
| | k | A4 | A6 | A8 | A10 |
| R1 | 7.6441E+00 | 8.3837E−05 | −3.4100E−07 | 8.2647E−10 | −8.6871E−13 |
| R2 | −1.4507E+00 | 6.1554E−05 | 2.0760E−06 | −2.5816E−08 | 7.6266E−11 |
| R3 | / | / | / | / | / |
| R4 | / | / | / | / | / |
| R5 | / | / | / | / | / |
| R6 | / | / | / | / | / |
| R7 | / | / | / | / | / |
| R8 | / | / | / | / | / |
| R9 | −4.6211E−01 | −1.5020E−04 | 2.0535E−06 | −8.8581E−08 | 7.0288E−10 |
| R10 | −6.0298E−01 | 3.2352E−04 | −5.5237E−06 | 4.9334E−08 | −4.3360E−11 |
| R11 | / | / | / | / | / |
| R12 | / | / | / | / | / |
| R13 | / | / | / | / | / |
| R14 | / | / | / | / | / |
| R15 | / | / | / | / | / |
| R16 | / | / | / | / | / |
| R17 | −5.2410E−02 | −1.7203E−03 | 7.9759E−06 | −1.7473E−08 | 1.4052E−11 |
| R18 | −5.2096E+01 | −1.3501E−03 | 8.7869E−06 | −2.5459E−08 | 2.6579E−11 |

Additionally, Table 15 provided hereafter lists values corresponding to various parameters in the comparative embodiment and parameters specified in the conditional expressions.

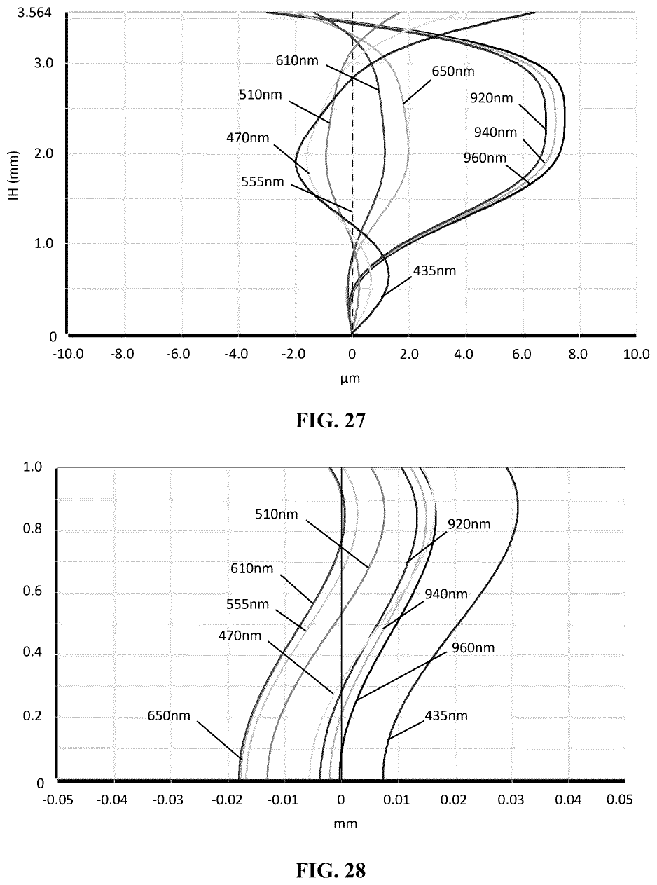

FIG. 26 illustrates field curvature and distortion diagrams of the camera optical lens 70 according to the comparative embodiment under light wavelengths of 555 nm and 940 nm. In FIG. 26, S denotes sagittal field curvature, and T denotes meridional field curvature. FIG. 27 illustrates magnification chromatic aberration diagrams of the camera optical lens 70 according to the comparative embodiment under light wavelengths of 435 nm, 470 nm, 510 nm, 555 nm, 610 nm, 650 nm, 920 nm, 940 nm, and 960 nm. FIG. 28 illustrates longitudinal aberration diagrams of the camera optical lens 70 according to the comparative embodiment under light wavelengths of 435 nm, 470 nm, 510 nm, 555 nm, 610 nm, 650 nm, 920 nm, 940 nm, and 960 nm.

As shown in Table 15, values corresponding to parameters in the comparative embodiment and the specified parameters in the conditional expression al expressions are additionally listed in this paper. Obviously, the camera optical lens 70 of the comparative embodiment does not meet the above conditional expression: 4.30≤f5/f≤6.80.

In this embodiment, the entrance pupil diameter of the camera optical lens 70 is 0.710 mm, the IH at 1.0 field is 3.564 mm, and the field of view FOV at 1.0 field is 130.33°. The camera optical lens 70 cannot meet the design requirements of large aperture and wide-angle characteristics while maintaining excellent optical performance across both visible and infrared light bands. Its on-axis and off-axis chromatic aberrations are not adequately corrected, lacking superior optical performance.

TABLE 15

| Parameters and | | | | |
|---|---|---|---|---|
| conditions | 1^{st} embodiment | 2^{nd} embodiment | 3^{rd} embodiment | 4^{th} embodiment |
| R3/R4 | 3.18 | 2.00 | 3.46 | 3.09 |
| f5/f | 5.87 | 4.32 | 6.74 | 5.29 |
| d10/TTL | 0.11 | 0.15 | 0.09 | 0.10 |
| f | 1.994 | 2.443 | 1.771 | 2.200 |
| f1 | −14.006 | −14.239 | −14.057 | −14.582 |
| f2 | −12.240 | −15.721 | −11.900 | −12.548 |
| f3 | −7.572 | −7.265 | −7.582 | −8.353 |
| f4 | 14.362 | 14.893 | 14.364 | 13.961 |
| f5 | 11.713 | 10.559 | 11.935 | 11.638 |
| f6 | −7.593 | −8.944 | −7.936 | −7.683 |
| f7 | 4.227 | 4.589 | 4.340 | 4.251 |
| f8 | −5.713 | −6.965 | 13.609 | −5.532 |
| f9 | 8.914 | 12.435 | −5.824 | 9.534 |
| FNO | 2.40 | 2.40 | 2.40 | 2.40 |
| TTL | 50.001 | 44.595 | 52.896 | 52.289 |
| IH | 3.564 | 3.564 | 3.564 | 3.564 |
| FOV | 121.04° | 109.41° | 125.45° | 115.00° |

| Parameters and | | | Comparative | |
|---|---|---|---|---|
| conditions | 5^{th} embodiment | 6^{th} embodiment | embodiment | / |
| R3/R4 | 4.00 | 3.04 | 3.43 | / |
| f5/f | 5.28 | 6.25 | 6.89 | / |
| d10/TTL | 0.13 | 0.11 | 0.10 | / |
| f | 2.141 | 1.858 | 1.705 | / |
| f1 | −17.823 | −14.553 | −13.489 | / |
| f2 | −10.605 | −12.601 | −11.710 | / |
| f3 | −7.723 | −7.028 | −7.489 | / |
| f4 | 13.875 | 15.331 | 14.412 | / |
| f5 | 11.297 | 11.612 | 11.745 | / |
| f6 | −8.915 | −8.115 | −7.691 | / |
| f7 | 4.591 | 4.352 | 4.200 | / |
| f8 | −6.845 | −5.712 | −5.732 | / |
| f9 | 10.336 | 8.921 | 8.574 | / |
| FNO | 2.40 | 2.40 | 2.40 | / |
| TTL | 45.544 | 50.652 | 50.619 | / |
| IH | 3.564 | 3.564 | 3.564 | / |
| FOV | 118.50° | 124.97° | 130.33° | / |

A detailed description has been provided herein for the camera optical lens according to the embodiments of the present disclosure. Specific examples are used to illustrate the principles and implementations of the present disclosure. The foregoing descriptions of the embodiments are intended solely to facilitate understanding of the inventive concepts. Specific implementations and application scopes are subject to modifications. Therefore, the content of this specification shall not be construed as limiting the present disclosure.

What is claimed is:

1. A camera optical lens, comprising nine lenses, wherein from an object side to an image side, the nine lenses comprise in sequence: a first lens having a negative refractive power, a second lens having a negative refractive power, a third lens having a negative refractive power, a fourth lens having a positive refractive power, a fifth lens having a positive refractive power, a sixth lens having a negative refractive power, a seventh lens having a positive refractive power, an eighth lens having a positive refractive power, and a ninth lens having a positive refractive power; wherein
an object side surface of the first lens is convex in a paraxial region, and an image side surface of the first lens is concave in the paraxial region;
an object side surface of the second lens is convex in a paraxial region, and an image side surface of the second lens is concave in the paraxial region;
an object side surface of the third lens is concave in a paraxial region, and an image side surface of the third lens is concave in the paraxial region;
an object side surface of the fourth lens is convex in a paraxial region, and an image side surface of the fourth lens is convex in the paraxial region;
an object side surface of the fifth lens is convex in a paraxial region, and an image side surface of the fifth lens is convex in the paraxial region;
an object side surface of the sixth lens is convex in a paraxial region, and an image side surface of the sixth lens is concave in the paraxial region;
an object side surface of the seventh lens is convex in a paraxial region, and an image side surface of the seventh lens is convex in the paraxial region;
an object side surface of the eighth lens is concave in a paraxial region, and an image side surface of the eighth lens is convex in the paraxial region;
an object side surface of the ninth lens is convex in a paraxial region, and an image side surface of the ninth lens is convex in the paraxial region;
a central curvature radius of the object side surface of the second lens is denoted as R3, a central curvature radius of the image side surface of the second lens is denoted as R4, a focal length of the fifth lens is denoted as f5, an on-axis distance between the fifth lens and the sixth lens is denoted as d10, a focal length of the camera optical lens is denoted as f, a total track length of the camera optical lens is denoted as TTL, and the camera optical lens satisfies:
$$2. \leq R 3 / R 4 \leq 4. ;$$
$$4.3 \leq f 5 / f \leq 6.8 ;$$
$$0.09 \leq d 10 / TTL \leq 0.15 .$$

2. The camera optical lens according to claim 1, wherein a refractive index of the first lens is denoted as nd1, and nd1 satisfies:
$$1.7 \leq nd 1 \leq 2.2 .$$

3. The camera optical lens according to claim 2, wherein the refractive index nd1 of the first lens satisfies:
$$1.71 \leq nd 1 \leq 1.82 .$$

4. The camera optical lens according to claim 1, wherein a focal length of the third lens is denoted as f3, a focal length of the fourth lens is denoted as f4, f3 and f4 satisfy:
$$- 0.60 \leq f 3 / f 4 \leq - 0.45 .$$

5. The camera optical lens according to claim 1, wherein a field of view of the camera optical lens at 1.0 field is denoted as FOV, and an image height of the camera optical lens at the 1.0 field is denoted as IH, FOV and IH satisfy:
$$60. \leq ( FOV * f ) / IH \leq 75. .$$

6. The camera optical lens according to claim 5, wherein the camera optical lens satisfies:
$$62. \leq ( FOV * f ) / IH \leq 75. .$$

7. The camera optical lens according to claim 1, wherein a back focal length of the camera optical lens is denoted as BFL, and BFL satisfies:
$$0.05 \leq B F L / T T L \leq 0.10 .$$

8. The camera optical lens according to claim 1, wherein
a central curvature radius of the object side surface of the first lens is denoted as R1, a central curvature radius of the image side surface of the first lens is denoted as R2, a focal length of the first lens is denoted as f1, and an on-axis thickness of the first lens is denoted as d1, satisfying:
$$1.34 \leq ( R 1 + R 2 ) / ( R 1 - R 2 ) \leq 1.55 ;$$
$$- 8.33 \leq f 1 / f \leq - 5.82 ;$$
$$0.05 \leq d 1 / TTL \leq 0.09 .$$

9. The camera optical lens according to claim 1, wherein
a focal length of the second lens is denoted as f2, and an on-axis thickness of the second lens is denoted as d3, satisfying:
$$1.66 \leq ( R 3 + R 4 ) / ( R 3 - R 4 ) \leq 3. ;$$
$$- 6.8 \leq f 2 / f \leq - 4.95 ;$$
$$0.01 \leq d 3 / TTL \leq 0.06 .$$

10. The camera optical lens according to claim 1, wherein
a central curvature radius of the object side surface of the third lens is denoted as R5, a central curvature radius of the image side surface of the third lens is denoted as R6, a focal length of the third lens is denoted as f3, and an on-axis thickness of the third lens is denoted as d5, satisfying:
$$- 0.24 \leq ( R 5 + R 6 ) / ( R 5 - R 6 ) \leq - 0 \text{.07} ;$$
$$- 4.29 \leq f 3 / f \leq - 2.97 ;$$
$$0.01 \leq d 5 / TTL \leq 0.04 .$$

11. The camera optical lens according to claim 1, wherein
a central curvature radius of the object side surface of the fourth lens is denoted as R7, a central curvature radius of the image side surface of the fourth lens is denoted as R8, a focal length of the fourth lens is denoted as f4, and an on-axis thickness of the fourth lens is denoted as d7, satisfying:
$$- 0.1 \; 0 \leq ( R 7 + R 8 ) / ( R 7 - R 8 ) \leq 0 \text{.01} ;$$
$$6.09 \leq f 4 / f \leq 8.26 ;$$
$$0.22 \leq d 7 / TTL \leq 0.26 .$$

12. The camera optical lens according to claim 1, wherein
a central curvature radius of the object side surface of the fifth lens is denoted as R9, a central curvature radius of the image side surface of the fifth lens is denoted as R10, and an on-axis thickness of the fifth lens is denoted as d9, satisfying:
$$- 0.3 \; 9 \leq ( R 9 + R 10 ) / ( R 9 - R 10 ) \leq - 0 \text{.32} ;$$
$$4.32 \leq f 5 / f \leq 6.74 ;$$
$$0.09 \leq d 9 / TTL \leq 0.14 .$$

13. The camera optical lens according to claim 1, wherein
a central curvature radius of the object side surface of the sixth lens is denoted as R11, a central curvature radius of the image side surface of the sixth lens is denoted as R12, a focal length of the sixth lens is denoted as f6, and an on-axis thickness of the sixth lens is denoted as d11, satisfying:
$$3.04 \leq ( R 11 + R 12 ) / ( R 11 - R 12 ) \leq 3.52 ;$$
$$- 4.5 \leq f 6 / f \leq - 3.49 ;$$
$$0.01 \leq d 11 / TTL \leq 0.02 .$$

14. The camera optical lens according to claim 1, wherein
a central curvature radius of the object side surface of the seventh lens is denoted as R13, a central curvature radius of the image side surface of the seventh lens is denoted as R14, a focal length of the seventh lens is denoted as f7, and an on-axis thickness of the seventh lens is denoted as d13, satisfying:
$$- 0.5 \; 1 \leq ( R 13 + R 14 ) / ( R 13 - R 14 ) \leq - 0 \text{.39} ;$$
$$1.87 \leq f 7 / f \leq 2.5 ;$$
$$0.03 \leq d 13 / TTL \leq 0.05 .$$

15. The camera optical lens according to claim 1, wherein
a central curvature radius of the object side surface of the eighth lens is denoted as R15, a central curvature radius of the image side surface of the eighth lens is denoted as R16, a focal length of the eighth lens is denoted as f8, and an on-axis thickness of the eighth lens is denoted as d15, satisfying:
$$0.08 \leq ( R 15 + R 16 ) / ( R 15 - R 16 ) \leq 0.41 ;$$
$$3.2 \leq f 8 / f \leq 7.7 ;$$
$$0. \leq d 15 / TTL \leq 0.02 .$$

16. The camera optical lens according to claim 1, wherein
a central curvature radius of the object side surface of the ninth lens is denoted as R17, a central curvature radius of the image side surface of the ninth lens is denoted as R18, a focal length of the ninth lens is denoted as f9, and an on-axis thickness of the ninth lens is denoted as d17, satisfying:
$$- 0.9 \; 5 \leq ( R 17 + R 18 ) / ( R 17 - R 18 ) \leq - 0 \text{.16} ;$$
$$- 3.3 \leq f 9 / f \leq 5.1 ;$$
$$0. \leq d 17 / TTL \leq 0.04 .$$

17. The camera optical lens according to claim 1, wherein the first lens, the second lens, the third lens, the fourth lens, the fifth lens, the sixth lens, the seventh lens, the eighth lens, and the ninth lens are glass lenses.
